(19) United States
(12) Patent Application Publication
(10) Pub. No.: US 2026/0300087 A1
(43) Pub. Date: Oct. 1, 2026

(54) DATA PROCESSING DEVICE, DATA PROCESSING METHOD, AND NON-TRANSITORY COMPUTER READABLE STORAGE MEDIUM

(71) Applicant: MegaChips Corporation, Osaka (JP)

(72) Inventors: Tomoka TAKAHASHI, Osaka (JP); Ippei TANAKA, Osaka (JP)

(73) Assignee: MegaChips Corporation, Osaka (JP)

(21) Appl. No.: 19/408,519

(22) Filed: Dec. 4, 2025

(30) Foreign Application Priority Data
Mar. 28, 2025 (JP) 2025-055256

(51) Int. Cl. G06F 11/10; G06F 11/07

(52) U.S. Cl. CPC G06F 11/1044; G06F 11/0772

(57) ABSTRACT

Provided is a data processing device that is provided at low cost without requiring large-scale hardware, and performs high-performance data error detection and correction, thereby enabling countermeasures against fault attacks. In a data processing device, one-hot representation data is adopted as the data to be written to a state register, and simple processing (e.g., bit AND operation processing) between the data in the duplicated state registers is performed, allowing error correction processing to be performed. This allows for low-cost implementation without requiring large-scale hardware, while also achieving high-performance data error correction processing. Furthermore, in the data processing device, since only simple processing (e.g., bit AND operations) is performed between the data in the duplicated state registers, high-speed processing can be achieved.

### CROSS-REFERENCE TO RELATED APPLICATION

This application claims priority to Japanese Patent Application No. 2025-055256 filed on Mar. 28, 2025, the entire disclosure of which is hereby incorporated herein by reference (IBR).

### BACKGROUND OF THE INVENTION

### Field of the Invention

The present invention relates to techniques for countermeasures against fault attacks, which are attacks to hardware intentionally causing malfunction by injecting faults (errors and/or disorders) into devices in operation.

### Description of the Background Art

Ensuring confidentiality and authentication of information can be achieved by using various cryptographic algorithms. However, cryptographic algorithms are countermeasures against data on devices and communication paths, and are not resistant to attack methods that physically access devices in operation and steal information. Such attack methods are broadly referred to as side-channel attacks (SCA: Side Channel Attack). Additionally, side-channel attacks can be further categorized based on the type of physical attack method used; non-intrusive side-channel attacks are referred to as narrowly defined side-channel attacks, whereas intrusive side-channel attacks are referred to as fault attacks. Devices that detect errors to counter such fault attacks are being developed. For example, Patent Document 1 (Document 1: Japanese Patent No. 5164154) discloses a device that divides encoding and decoding processes into pipelines and performs verification processing in parallel with the processing to enable error detection during processing. Such a device can defend against attacks that intentionally cause errors to steal information, such as fault exploitation analysis attacks against symmetric key cryptography, and can take measures such as immediately stopping processing when an error is detected.

However, with the conventional technology described above, complex encoding and decoding processes must be performed frequently using pipeline processing, and verification processing is also required. This results in large circuit sizes, and furthermore, high-performance large-scale hardware is necessary to perform high-speed processing in devices in operation, leading to high implementation costs.

In view of the above problems, it is an object of the present invention to provide a data processing device, a data processing method, and a non-transitory computer readable storage medium storing a program, which can be provided at low cost without requiring large-scale hardware, that perform high-performance data error detection and correction, thus allowing for performing fault attack countermeasures.

### SUMMARY

To solve the above problems, a first aspect of the present invention provides a data processing device for controlling data processing by transitioning between a finite number of defined states, the data processing device including a first register, a second register, state obtaining circuitry, and error processing circuitry.

The first register is a register capable of storing and retaining data.

The second register is a register capable of storing and retaining data.

The state obtaining circuitry includes a state obtaining processing circuitry that receives a state transition control signal, determines a next state to be transitioned to based on a current state and the state transition control signal, obtains one-hot representation data or one-cold representation data representing the determined state. The state obtaining circuitry transmits the one-hot representation data or the one-cold representation data to the first register and the second register.

The error processing circuitry includes an error correction processing circuitry that receives data stored in the first register as first data, receives data stored in the second register as second data, performs error correction processing based on the first data and the second data to obtain data after error correction processing.

### BRIEF DESCRIPTION OF DRAWINGS

FIG. 1 is a schematic configuration diagram of a data processing device 1000 according to a first embodiment.

FIG. 2 is a diagram showing a table indicating the relationship between the state and the state register value in the data processing device 1000 according to the first embodiment.

FIG. 3 is a diagram showing a state transition diagram and a state transition table (a table indicating the relationship between the current state, the state register value, the state transition control signal value (input value), and the next state) in the data processing device 1000 according to the first embodiment.

FIG. 4 is a diagram (timing chart) showing the relationship between a state transition control signal Din and the state of the data processing device 1000 according to the first embodiment.

FIG. 5 is a diagram for explaining error correction processing in the data processing device 1000 according to the first embodiment.

FIG. 6 is a schematic configuration diagram of a data processing device 2000 according to a second embodiment.

FIG. 7 is a diagram for explaining error detection processing performed by a state machine unit 100A of the data processing device 2000 according to the second embodiment.

FIG. 8 is a diagram for explaining error detection processing in a first modification according to the second embodiment.

FIG. 9 is a schematic configuration diagram of a data processing device 3000 according to a third embodiment.

FIG. 10 is a diagram for explaining error detection processing performed by a state machine unit 100B of the data processing device 3000 according to the third embodiment.

FIG. 11 is a schematic configuration diagram of a data processing device 4000 according to a fourth embodiment.

FIG. 12 is a diagram showing a table indicating the relationship between the state and the state register value (split register value) in the data processing device 4000 according to the fourth embodiment.

FIG. 13 is a diagram for explaining split registers in the data processing device 4000 according to the fourth embodiment.

FIG. 14 is a schematic configuration diagram of a data processing device 5000 according to a fifth embodiment.

FIG. 15 is a diagram for explaining encoding processing (bit reduction processing) and decoding processing (bit expansion processing) performed by a state machine unit 100D of the data processing device 5000 according to the fifth embodiment (in a case of n=2).

FIG. 16 is a diagram for explaining encoding processing (bit reduction processing) and decoding processing (bit expansion processing) performed by the state machine unit 100D of the data processing device 5000 according to the fifth embodiment (in a case of n=3).

FIG. 17 is a schematic configuration diagram of a data processing device 6000 according to a sixth embodiment.

FIG. 18 is a diagram for explaining encoding processing (bit reduction processing) and decoding processing (bit expansion processing) performed by a state machine unit 100E of the data processing device 6000 according to the sixth embodiment (in a case of n=2).

FIG. 19 is a diagram for explaining encoding processing (bit reduction processing) and decoding processing (bit expansion processing) performed by the state machine unit 100E of the data processing device 6000 according to the sixth embodiment (in a case of n=3).

FIG. 20 is a diagram showing a CPU bus configuration.

### DESCRIPTION OF EMBODIMENTS

### First Embodiment

The first embodiment will be described below with reference to drawings.

### 1.1: Configuration of Data Processing Device

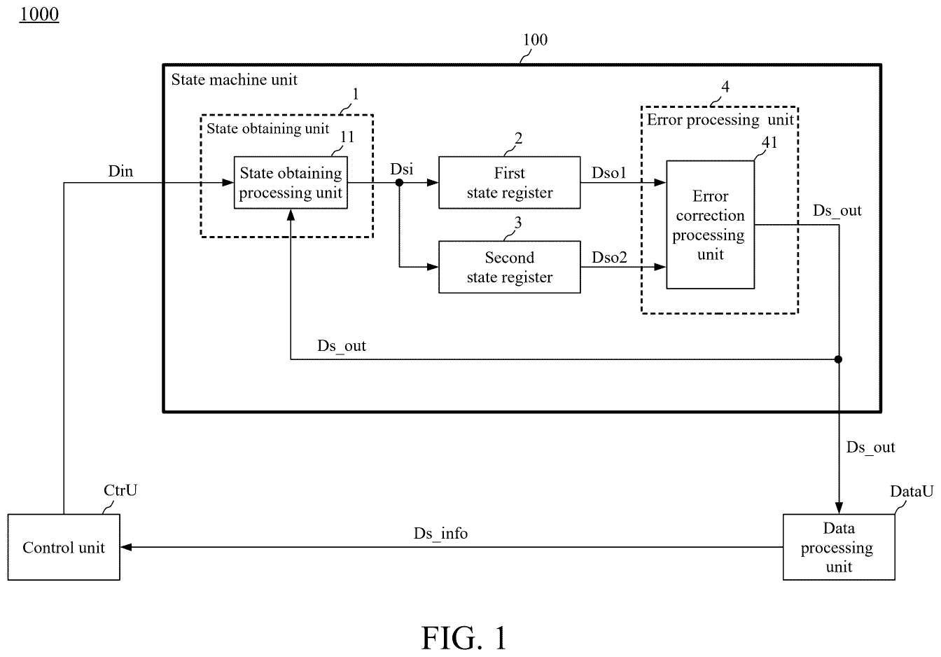

FIG. 1 is a schematic configuration diagram of a data processing device 1000 according to a first embodiment.

The data processing device 1000, as shown in FIG. 1, includes a control unit CtrU, a state machine unit 100, and a data processing unit DataU.

The control unit CtrU receives a state transition-related signal Ds_info from the data processing unit DataU, generates a state transition control signal Din based on the state transition-related signal Ds_info, and then transmits the generated state transition control signal Din to the state machine unit 100.

The state machine unit 100 is a functional unit that receives the state transition control signal Din transmitted from the control unit CtrU and transmits a signal (state indication signal) Ds_out indicating the state to the data processing unit DataU, and is provided, for example, by a state machine (finite automaton). The state machine unit 100 includes, as shown in FIG. 1, a state obtaining unit 1, a first state register 2, a second state register 3, and an error processing unit 4.

The state obtaining unit 1 includes a state obtaining processing unit 11.

The state obtaining processing unit 11 receives the state transition control signal Din transmitted from the control unit CtrU and the state indication signal Ds_out transmitted from the error processing unit 4. The state obtaining processing unit 11 performs processing (state obtaining processing) for obtaining a state to be transitioned to based on the state transition control signal Din and the state indication signal Ds_out, and transmits data indicating the state obtained by the processing as data Dsi to the first state register 2 and the second state register 3.

The first state register 2 is a register (data storage device) capable of storing N-bit data (N is a natural number). The first state register 2 receives data Dsi transmitted from the state obtaining processing unit 11 and stores the data Dsi. In addition, the first state register 2 transmits the data stored therein, as data Dso1, to an error correction processing unit 41.

The second state register 3 is a register (data storage device) capable of storing N-bit data (N is a natural number). The second state register 3 receives data Dsi transmitted from the state obtaining processing unit 11 and stores the data Dsi. In addition, the second state register 3 transmits the stored data stored therein, as data Dso2, to the error correction processing unit 41.

The error processing unit 4 includes the error correction processing unit 41.

The error correction processing unit 41 receives the data Dso1 transmitted from the first state register 2 and the data Dso2 transmitted from the second state register 3. The error correction processing unit 41 then performs error correction processing using the received data Dso1 and Dso2, and transmits the processed data as data Dso_out to the state obtaining unit 1 and the data processing unit DataU.

The data processing unit DataU is a device that performs predetermined data processing, receives the data Ds_out (state indication signal) transmitted from the state machine unit 100, and performs processing corresponding to the state indicated by the state indication signal. Further, the data processing unit DataU transmits a signal containing information related to state transitions as a state transition-related signal Ds_info to the control unit CtrU.

### 1.2: Operation of Data Processing Device

The operation of the data processing device 1000 configured as described above will now be described.

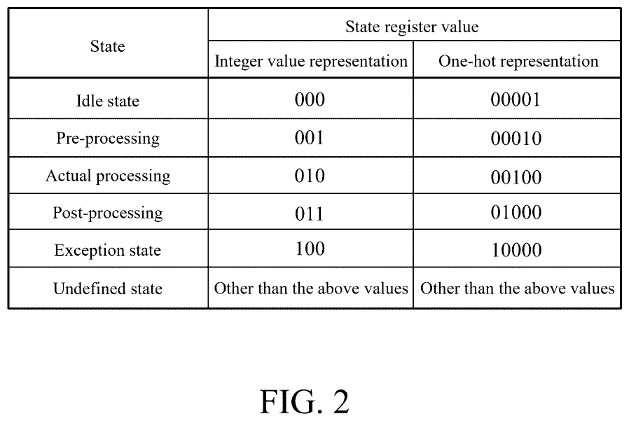

FIG. 2 is a diagram showing a table indicating the relationship between the state and the state register value in the data processing device 1000 according to the first embodiment.

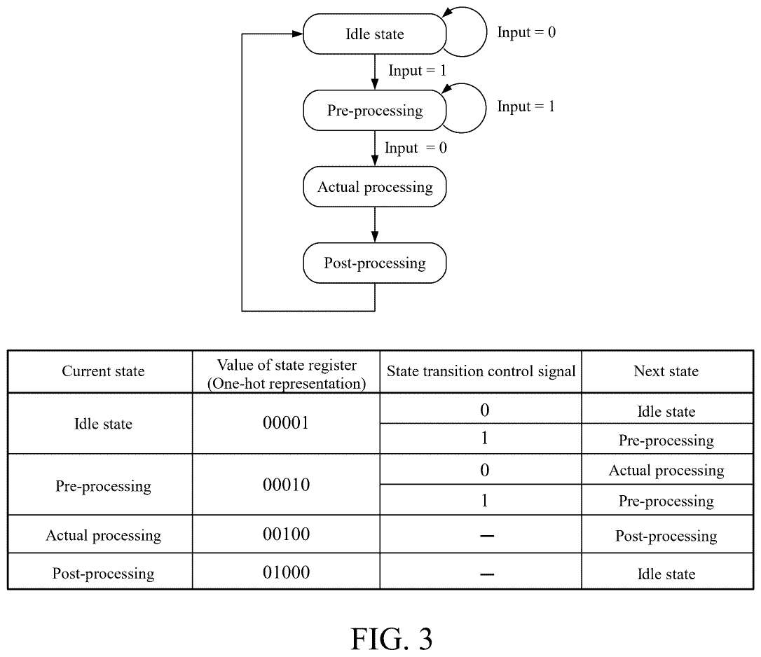

FIG. 3 is a diagram showing a state transition diagram and a state transition table (a table indicating the relationship between the current state, the state register value, the state transition control signal value (input value), and the next state) in the data processing device 1000 according to the first embodiment.

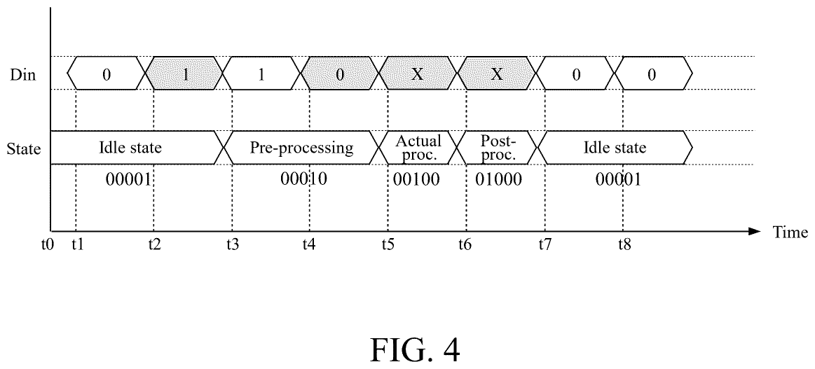

FIG. 4 is a diagram (timing chart) showing the relationship between the state transition control signal Din and the state of the data processing device 1000 according to the first embodiment.

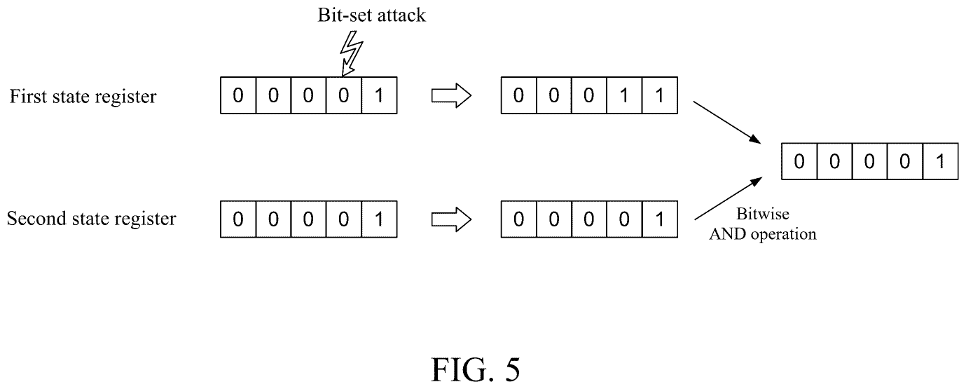

FIG. 5 is a diagram for explaining error correction processing in the data processing device 1000 according to the first embodiment.

In the data processing device 1000, the state machine unit 100 duplicates the state registers, and data stored in the state registers is one-hot representation data.

For the sake of explanation, in data processing device 1000, states are defined as shown in FIG. 2. In other words, in data processing device 1000, the state register is assumed to be a register for 5-bit one-hot representation data, and
(1) when the state is “idle state”, the value of the state register is set to “000” (integer value representation) (one-hot representation “00001”),
(2) when the state is “pre-processing” (state while pre-processing is being performed), the value of the state register is set to “001” (integer value representation) (one-hot representation: “00010”),
(3) when the state is “actual processing” (state while actual processing is being performed), the value of the state register is set to “010” (integer value representation) (one-hot representation: “00100”),
(4) when the state is “post-processing” (state while post-processing is being performed), the value of the state register is set to “011” (integer value representation) (one-hot representation: “01000”),
(5) when the state is “exception state”, the value of the state register is set to “100” (integer value representation) (one-hot representation: “10000”).

In the data processing device 1000, when the value of the state register is other than the above values, it is determined to be an “undefined state” (an undefined state).

For convenience of explanation, the states of the data processing device 1000 are assumed to transition as shown in the state transition diagram in the upper figure of FIG. 3. In other words, the next state is determined based on the values of the state transition control signal Din, which is the input to the state machine unit 100, and the current state, in accordance with the table shown in the lower figure of FIG. 3.

The operation of the data processing device 1000 will be described below with reference to the drawings.

As an example, a case where the state transitions in the data processing device 1000 as shown in FIG. 4 will be described.

### Time t0

At time t0, the state of data processing device 1000 is “idle state”, and the first state register 2 and the second state register 3 of the state machine unit 100 are both set to “00001” (initial state).

The error correction processing unit 41 of the state machine unit 100 receives the data stored in the first state register 2 as data Dso1, and receives the data stored in the second state register 3 as data Dso2. Note that the first state register 2 and the second state register 3 store the received data for a period equivalent to one clock cycle (one cycle period) and transmit the stored data one cycle later (one clock cycle later) from the timing of data input.

### Time t1

The error correction processing unit 41 then performs error correction processing using the data Dso1 and the data Dso2 (data inputted into the first state register 2 and the second state register 3 at the previous time (one cycle before the current time)). Specifically, the error correction processing unit 41 performs error correction processing by performing a bitwise AND operation (bit AND operation) on the data input from the first state register 2 and the data input from the second state register 3. At time t1, if there are no errors, the data in the first state register 2 (“00001”) and the data in the second state register 3 (“00001”) are identical, so that the data after the error correction processing is the same as the data in the first state register 2 and the second state register 3 (“00001”).

Further, the error correction processing unit 41 determines whether the data after the correction processing is one-hot representation data; (1) when the data after the correction processing is determined to be one-hot representation data, the data after the correction processing is transmitted as data Ds_out to the data processing unit DataU and the state obtaining unit 1, whereas (2) when the corrected data is determined not to be one-hot representation data, for example, data indicating an exception state (“10000”) is transmitted as data Ds_out to the data processing unit DataU and the state obtaining unit 1.

The data Ds_out transmitted from the state machine unit 100 is “00001”, and thus the data processing unit DataU performs processing corresponding to the idle state.

At time t1, the data processing unit DataU transmits a state transition-related signal Ds_info containing information related to the state transition obtained by the data processing unit DataU (e.g., information indicating that the processing for the idle state is being performed in the data processing unit DataU) to the control unit CtrU.

The control unit CtrU receives the state transition-related signal Ds_info from the data processing unit DataU and generates a state transition control signal Din based on the state transition-related signal Ds_info. Specifically, the control unit CtrU generates the state transition control signal Din with a signal value of “0” and then transmits the generated state transition control signal Din to the state machine unit 100.

The state obtaining processing unit 11 receives the state transition control signal Din transmitted from the control unit CtrU and the state indication signal Ds_out transmitted from the error correction processing unit 41. The state obtaining processing unit 11 performs processing (state obtaining processing) for obtaining a state to be transitioned to based on the state transition control signal Din and the state indication signal Ds_out.

At time t1, since the state indication signal Ds_out (=“00001”) indicates that the current state is “idle state” and the value of the state transition control signal Din is “0”, the state obtaining processing unit 11 sets the data Dsi to “00001” (idle state)(refer to the state transition diagram in FIG. 3) so that the next state becomes “idle state” (maintains the idle state), and then transmits the data Dsi to the first state register 2 and the second state register 3.

The first state register 2 and the second state register 3 store the data Dsi (=“00001”) transmitted from the state obtaining processing unit 11.

### Time t2

The error correction processing unit 41 of the state machine unit 100 receives the data Dso1 transmitted from the first state register 2 and the data Dso2 transmitted from the second state register 3. The error correction processing unit 41 then performs error correction processing using the received data Dso1 and data Dso2. Specifically, the error correction processing unit 41 performs error correction processing by performing a bitwise AND operation (bit AND operation) on the data inputted from the first state register 2 and the data inputted from the second state register 3 (the data inputted into the first state register 2 and the second state register 3 at the previous time (one cycle before the current time)) to correct errors. At time t2, when there are no errors, the data in the first state register 2 (“00001”) and the data in the second state register 3 (“00001”) are the same, so that the data after the error correction processing is the same as the data in the first state register 2 and the second state register 3 (“00001”).

The error correction processing unit 41 then transmits the data after the above correction processing as data Ds_out to the data processing unit DataU and the state obtaining unit 1.

The data Ds_out transmitted from the state machine unit 100 is “00001”, and thus the data processing unit DataU performs processing corresponding to the idle state.

At time t2, the data processing unit DataU transmits the state transition-related signal Ds_info containing information related to the state transition obtained by the data processing unit DataU (e.g., information indicating that the processing of the idle state has been completed in the data processing unit DataU) to the control unit CtrU.

The control unit CtrU receives the state transition-related signal Ds_info from the data processing unit DataU and generates the state transition control signal Din based on the state transition-related signal Ds_info. Here, the control unit CtrU generates the state transition control signal Din with a signal value of “1” and then transmits the generated state transition control signal Din to the state machine unit 100.

The state obtaining processing unit 11 receives the state transition control signal Din (=1) transmitted from the control unit CtrU and the state indication signal Ds_out transmitted from the error correction processing unit 41. The state obtaining processing unit 11 performs processing (state obtaining processing) for obtaining a state to be transitioned to based on the state transition control signal Din and the state indication signal Ds_out.

At time t2, since the current state is “idle state” from the state indication signal Ds_out and the value of the state transition control signal Din is “1”, the state obtaining processing unit 11 sets the data Dsi to “00010” (pre-processing) (refer to the state transition diagram in FIG. 3) so that the next state becomes “pre-processing” (the state is transitioned from the idle state to pre-processing), and then transmits the data Dsi to the first state register 2 and the second state register 3.

The first state register 2 and the second state register 3 store the data Ds (=“00010”) transmitted from the state obtaining processing unit 11.

### Time t3

The error correction processing unit 41 of the state machine unit 100 receives the data Dso1 transmitted from the first state register 2 and the data Dso2 transmitted from the second state register 3. The error correction processing unit 41 then performs error correction processing using the received data Dso1 and Dso2. Specifically, the error correction processing unit 41 performs the error correction processing by performing a bitwise AND operation (bit AND operation) on the data inputted from the first state register 2 and the data inputted from the second state register 3 (the data inputted into the first state register 2 and the second state register 3 at the previous time (one cycle before the current time)). At time t3, when there are no errors, the data in the first state register 2 (“00010”) and the data in the second state register 3 (“00010”) are the same, so that the data after the above error correction processing is the same as the data in the first state register 2 and the data in the second state register 3 (“00010”).

The error correction processing unit 41 then transmits the data after the above correction processing as data Ds_out to the data processing unit DataU and the state obtaining unit 1.

The data Ds_out transmitted from the state machine unit 100 is “00010”, and thus the data processing unit DataU performs pre-processing.

At time t3, the data processing unit DataU transmits a state transition-related signal Ds_info containing information related to the state transition obtained by the data processing unit DataU (e.g., information indicating that the pre-processing is being performed in the data processing unit DataU) to the control unit CtrU.

The control unit CtrU receives the state transition-related signal Ds_info from the data processing unit DataU and generates the state transition control signal Din based on the state transition-related signal Ds_info. Here, the control unit CtrU generates the state transition control signal Din with a signal value of “1” and then transmits the generated state transition control signal Din to the state machine unit 100.

The state obtaining processing unit 11 receives the state transition control signal Din (=1) transmitted from the control unit CtrU and the state indication signal Ds_out transmitted from the error correction processing unit 41. The state obtaining processing unit 11 performs processing (state obtaining processing) for obtaining the state to be transitioned to based on the state transition control signal Din and the state indication signal Ds_out.

At time t3, since the current state is “pre-processing” based on the state indication signal Ds_out and the value of the state transition control signal Din is “1”, the state obtaining processing unit 11 sets the data Dsi to “00010” (pre-processing) (refer to the state transition diagram in FIG. 3) so that the next state becomes “pre-processing” (maintains pre-processing), and then transmits the data Dsi to the first state register 2 and the second state register 3.

The first state register 2 and the second state register 3 store the data Ds (=“00010”) transmitted from the state obtaining processing unit 11.

### Time t4

The error correction processing unit 41 of the state machine unit 100 receives the data Dso1 transmitted from the first state register 2 and the data Dso2 transmitted from the second state register 3. The error correction processing unit 41 then performs error correction processing using the received data Dso and data Dso2. Specifically, the error correction processing unit 41 performs error correction processing by performing a bitwise AND operation (bit AND operation) on the data inputted from the first state register 2 and the data inputted from the second state register 3 (the data inputted into the first state register 2 and the second state register 3 at the previous time (one cycle before the current time)). At time t4, when there are no errors, the data in the first state register 2 (“00010”) and the data in the second state register 3 (“00010”) are the same, so that the data after the error correction processing is the same as the data in the first state register 2 and the second state register 3 (“00010”).

The error correction processing unit 41 then transmits the data after the above correction processing as data Ds_out to the data processing unit DataU and the state obtaining unit 1.

The data Ds_out transmitted from the state machine unit 100 is “00010”, and thus the data processing unit DataU performs pre-processing.

At time t4, the data processing unit DataU transmits the state transition-related signal Ds_info indicating that the data processing unit DataU has completed the pre-processing to the control unit CtrU.

The control unit CtrU receives the state transition-related signal Ds_info from the data processing unit DataU and generates a state transition control signal Din based on the state transition-related signal Ds_info. Here, the control unit CtrU generates the state transition control signal Din with a signal value of “0” and then transmits the generated state transition control signal Din to the state machine unit 100.

The state obtaining processing unit 11 receives the state transition control signal Din transmitted from the control unit CtrU and the state indication signal Ds_out transmitted from the error correction processing unit 41. The state obtaining processing unit 11 performs processing (state obtaining processing) for obtaining a state to be transitioned to based on the state transition control signal Din and the state indication signal Ds_out.

At time t4, since the current state is “pre-processing” based on the state indication signal Ds_out and the value of the state transition control signal Din is “0”, the state obtaining processing unit 11 sets the data Dsi to “00100” (actual processing) (refer to the state transition diagram in FIG. 3) so that the next state becomes “actual processing” (the state is transitioned from pre-processing to actual processing), and then transmits the data Dsi to the first state register 2 and the second state register 3.

The first state register 2 and the second state register 3 store the data Dsi (=“00100”) transmitted from the state obtaining processing unit 11.

### Time t5

The error correction processing unit 41 performs error correction processing using the received data Dso and data Dso2. Specifically, the error correction processing unit 41 performs a bitwise AND operation (bit AND operation) on the data inputted from the first state register 2 and the data inputted from the second state register 3 (the data inputted into the first state register 2 and the second state register 3 at the previous time (one cycle before the current time)) to perform the error correction processing. At time t5, if there are no errors, the data in the first state register 2 (“00100”) and the data in the second state register 3 (“00100”) are the same, so that the data after the error correction processing is the same as the data in the first state register 2 and the data in the second state register 3 (“00100”).

The error correction processing unit 41 then transmits the data after the above correction processing as data Ds_out to the data processing unit DataU and the state obtaining unit 1.

The data Ds_out transmitted from the state machine unit 100 is “00100”, and thus the data processing unit DataU performs actual processing.

At time t5, the data processing unit DataU transmits the state transition-related signal Ds_info indicating that the data processing unit DataU has completed the actual processing to the control unit CtrU.

The control unit CtrU receives the state transition-related signal Ds_info from the data processing unit DataU and generates the state transition control signal Din based on the state transition-related signal Ds_info. Here, the control unit CtrU generates a state transition control signal Din with a signal value of “X” (“0” or “1”) and then transmits the generated state transition control signal Din to the state machine unit 100.

The state obtaining processing unit 11 receives the state transition control signal Din transmitted from the control unit CtrU and the state indication signal Ds_out transmitted from the error correction processing unit 41. The state obtaining processing unit 11 performs processing (state obtaining processing) for obtaining a state to be transitioned to based on the state transition control signal Din and the state indication signal Ds_out.

At time t5, since the current state is “actual processing” from the state indication signal Ds_out and the value of the state transition control signal Din is “X” (“0” or “1”), the state obtaining processing unit 11 sets the data Dsi to “01000” (post-processing) (refer to the state transition diagram in FIG. 3) so that the next state becomes “post-processing” (the state is transitioned from actual processing to post-processing), and then transmits the data Dsi to the first state register 2 and the second state register 3.

The first state register 2 and the second state register 3 store the data Dsi (=“01000”) transmitted from the state obtaining processing unit 11.

### Time t6

The error correction processing unit 41 of the state machine unit 100 receives data Dso1 transmitted from the first state register 2 and the data Dso2 transmitted from the second state register 3. The error correction processing unit 41 then performs error correction processing using the received data Dso1 and data Dso2. Specifically, the error correction processing unit 41 performs the error correction processing by performing a bitwise AND operation (bit AND operation) on the data inputted from the first state register 2 and the data inputted from the second state register 3 (the data inputted into the first state register 2 and the second state register 3 at the previous time (one cycle before the current time)) to correct errors. At time t6, when there are no errors, the data in the first state register 2 (“01000”) and the data in the second state register 3 (“01000”) are the same, so that the data after the error correction processing is the same as the data in the first state register 2 and the data in the second state register 3 (“01000”).

The error correction processing unit 41 then transmits the data after the above correction processing as data Ds_out to the data processing unit DataU and the state obtaining unit 1.

The data Ds_out transmitted from the state machine unit 100 is “01000”, and thus the data processing unit DataU performs post-processing.

At time t6, the data processing unit DataU transmits the state transition-related signal Ds_info indicating that the data processing unit DataU has completed post-processing to the control unit CtrU.

The control unit CtrU receives the state transition-related signal Ds_info from the data processing unit DataU and generates a state transition control signal Din based on the state transition-related signal Ds_info. Here, the control unit CtrU generates the state transition control signal Din with a signal value of “X” (where “X” is either “0” or “1”) and then transmits the generated state transition control signal Din to the state machine unit 100.

The state obtaining processing unit 11 receives the state transition control signal Din transmitted from the control unit CtrU and the state indication signal Ds_out transmitted from the error correction processing unit 41. The state obtaining processing unit 11 performs processing (state obtaining processing) for obtaining a state to be transitioned to based on the state transition control signal Din and the state indication signal Ds_out.

At time t6, since the current state is “post-processing” from the state indication signal Ds_out and the value of the state transition control signal Din is “X”, the state obtaining processing unit 11 sets the data Dsi to “00001” (idle state) (refer to the state transition diagram in FIG. 3) so that the next state becomes “idle state” (the state is transitioned from post-processing to the idle state), and then transmits the data Dsi to the first state register 2 and the second state register 3.

The first state register 2 and the second state register 3 store the data Dsi (=“00001”) transmitted from the state obtaining processing unit 11.

### Time t7

The error correction processing unit 41 of the state machine unit 100 receives the data Dso1 transmitted from the first state register 2 and the data Dso2 transmitted from the second state register 3. The error correction processing unit 41 then performs error correction processing using the read-out data Dso1 and data Dso2. Specifically, the error correction processing unit 41 performs the error correction processing by performing a bitwise AND operation (bit AND operation) on the data inputted from the first state register 2 and the data inputted from the second state register 3 (the data inputted into the first state register 2 and the second state register 3 at the previous time (one cycle before the current time)). At time t7, when there are no errors, the data in the first state register 2 (“00001”) and the data in the second state register 3 (“00001”) are the same, so that the data after the error correction processing is the same as the data in the first state register 2 and the second state register 3 (“00001”).

The error correction processing unit 41 then transmits the data after the correction processing as data Ds_out to the data processing unit DataU and the state obtaining unit 1.

The data Ds_out transmitted from the state machine unit 100 is “00001”, and thus the data processing unit DataU performs processing corresponding to the idle state.

At time t7, the data processing unit DataU transmits the state transition-related signal Ds_info indicating that the data processing unit DataU is performing processing corresponding to the idle state to the control unit CtrU.

The control unit CtrU receives the state transition-related signal Ds_info from the data processing unit DataU and generates a state transition control signal Din based on the state transition-related signal Ds_info. Here, the control unit CtrU generates the state transition control signal Din with a signal value of “0” and then transmits the generated state transition control signal Din to the state machine unit 100.

The state obtaining processing unit 11 receives the state transition control signal Din transmitted from the control unit CtrU and the state indication signal Ds_out transmitted from the error correction processing unit 41. The state obtaining processing unit 11 performs processing (state obtaining processing) for obtaining a state to be transitioned to based on the state transition control signal Din and the state indication signal Ds_out.

At time t7, since the state indication signal Ds_out indicates that the current state is “idle state” and the value of the state transition control signal Din is “0”, the state obtaining processing unit 11 sets the data Dsi to “00001” (idle state) (refer to the state transition diagram in FIG. 3) so that the next state becomes “idle state” (maintains the idle state), and then transmits the data Dsi to the first state register 2 and the second state register 3.

The first state register 2 and the second state register 3 store the data Dsi (=“00001”) transmitted from the state obtaining processing unit 11.

### Time t8

At time t8, the same processing as at time t7 is performed.

As described above, in the data processing device 1000, data (the state register values after correction processing) obtained by performing error correction processing on the data from the duplicated state registers (the first state register 2 and the second state register 3) is transmitted to the data processing unit DataU as the state indication signal Ds_out, and the data processing unit DataU can perform processing corresponding to the state indication signal Ds_out. This allows the data processing device 1000 to perform the desired state transition when there are no errors in the state register values (i.e., when no fault attack has been performed), thus allowing the data processing unit DataU to perform the desired data processing.

Furthermore, even if a fault attack is performed on the state register(s), the data processing device 1000 can perform error correction processing and handle it appropriately. To illustrate this, a case shown in FIG. 5 will be described as an example.

As shown in FIG. 5, a case will be described in which when the data processing device 1000 is in the idle state and the first state register 2 and the second state register 3 are set to “00001”, a bit-set attack is performed on the second bit of the first state register 2.

In this case, as shown in FIG. 5, the first state register 2 becomes “00011”. The error correction processing unit 41 of the state machine unit 100 receives the data transmitted from the first state register 2 (“00011”) and the data transmitted from the second state register 3 (“00001”), and then performs a bitwise AND operation (bit AND operation) on both data to perform error correction processing. This allows the state machine unit 100 to obtain the error-corrected data “00001” (correct data).

The error correction processing unit 41 then transmits the data “00001” after the above error correction processing to the state obtaining unit 1 and the data processing unit DataU. This allows the data processing device 1000 to obtain the correct state register value even if a fault attack is performed on the state register, thus allowing the data processing unit DataU to perform the appropriate (desired) operation.

Note that when a bit-set attack is performed against the same-position bit(s) in the first state register 2 and the second state register 3, the error correction processing unit 41 detects that the data after correction processing is not one-hot representation, and then transmits, for example, data indicating an exception state (=“10000”) as data Ds_out (=“10000”) to the data processing unit DataU and the state obtaining unit 1. This allows the data processing unit DataU to perform, for example, exception handling. Processing in this manner allows the data processing device 1000 to appropriately prevent the data processing unit DataU from performing unintended operations even when error correction has not been successfully performed by the state machine unit 100.

### Summary of the Embodiment

As described above, the data processing device 1000 has a configuration in which the data to be written to the state register is one-hot representation data, and the state machine unit 100 includes the first state register 2 and the second state register 3, thereby duplicating the state registers. Further, a bitwise AND operation (bit AND operation) on the data in the first state register 2 and the data in the second state register 3, which are the duplicated state registers, is performed in the state machine unit 100, thereby allowing for performing error correction processing.

In other words, in the data processing device 1000, one-hot representation data is adopted as the data to be written to the state registers, and in the state machine unit 100, error correction processing can be performed simply by performing a bit AND operation between the data in the duplicated state registers, thereby enabling the realization of low-cost, high-performance data error correction processing without the need for large-scale hardware. Further, in the state machine unit 100, only the bit AND operation is performed between the data in the duplicated state registers (between one-hot representation data), thus achieving high-speed processing.

Note that the above description explains a case in which error correction processing is performed by storing one-hot representation data in the first state register 2 and the second state register 3 in the data processing device 1000, and then performing a bitwise AND operation on the data inputted from the first state register 2 and the second state register 3 in the error correction processing unit 41; however, this description should not be limited to this case. For example, in a data processing device 1000 that manages states as one-cold representation data, one-cold representation data may be stored in the first state register 2 and the second state register 3, and error correction processing may be performed by performing a bitwise OR operation on the data inputted from the first state register 2 and the second state register 3 in the error correction processing unit 41.

### Second Embodiment

Next, the second embodiment will be described. The same reference numerals are used for the same parts as in the above embodiment, and detailed descriptions are omitted.

### 2.1: Configuration of Data Processing Device

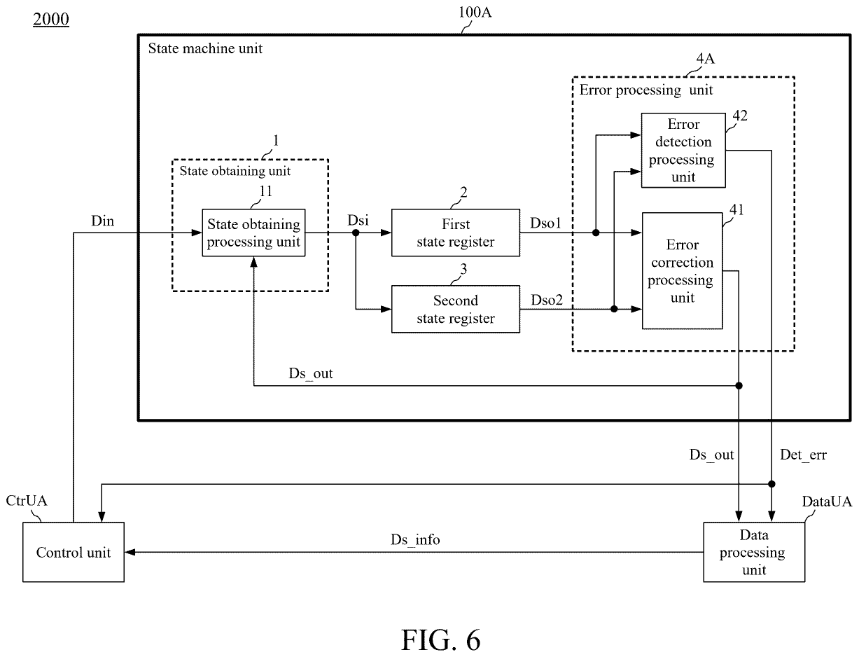

FIG. 6 is a schematic configuration diagram of a data processing device 2000 according to a second embodiment.

The data processing device 2000 of the second embodiment has a configuration in which, as shown in FIG. 6, the state machine unit 100 is replaced with a state machine unit 100A, the data processing unit DataU is replaced with a data processing unit DataUA, and the control unit CtrU is replaced with a control unit CtrUA in the data processing device 1000 of the first embodiment.

The state machine unit 100A has a configuration in which the error processing unit 4 of the state machine unit 100 of the first embodiment is replaced with an error processing unit 4A.

The error processing unit 4A includes an error correction processing unit 41 and an error detection processing unit 42, as shown in FIG. 6. The error correction processing unit 41 has the same configuration and functions as the error correction processing unit 41 of the first embodiment.

The error detection processing unit 42 receives data Dso1 transmitted from the first state register 2 and data Dso2 transmitted from the second state register 3. The error detection processing unit 42 then performs error detection processing using the received data Dso1 and Dso2, and transmits data including the detection result of the error detection processing as data Det_err (error detection signal Det_err) to the data processing unit DataUA and the control unit CtrUA.

The control unit CtrUA has the same functions as the control unit CtrU in the first embodiment, and further receives the data Det_err (error detection signal Det_err) transmitted from the state machine unit 100A and performs control processing based on the data Det_err (error detection signal Det_err).

### 2.2: Operation of Data Processing Device

The operation of the data processing device 2000 configured as described above will now be described. Details that are the same as those in the above embodiment are omitted.

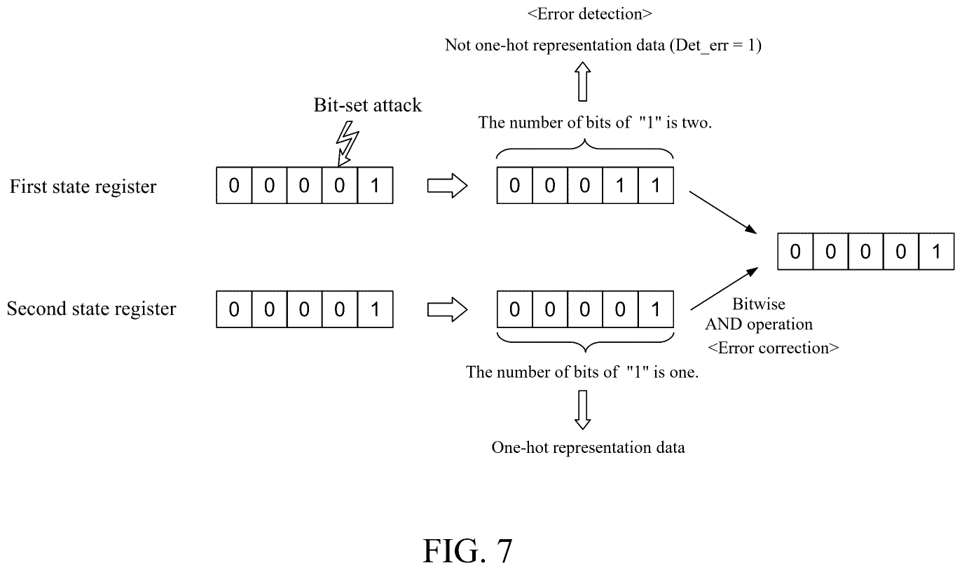

FIG. 7 is a diagram for explaining the error detection processing performed by the state machine unit 100A of the data processing device 2000 according to the second embodiment.

In the first embodiment, the data processing device 1000 can detect errors only when error correction has failed (error correction has not been successfully performed), whereas in the second embodiment, the data processing device 2000 can detect errors even when error correction has been successfully performed, in a case when an error has occurred (an error due to a fault attack has occurred).

For example, a case will be described in which the data processing device 2000 is in the idle state, the first state register 2 and the second state register 3 are set to “00001”, and a bit-set attack is performed on the second bit of the first state register 2, as shown in FIG. 7.

In this case, as shown in FIG. 7, the first state register 2 becomes “00011”. The error detection processing unit 42 of the state machine unit 100 detects the number of bits that are “1” in each of the data of the first state register 2 (“00011”) and the data of the second state register 3 (“00001”).

The error detection processing unit 42 detects that the data in the second state register 3 is “00001” and that the number of bits set to “1” is “1”. The error detection processing unit 42 then determines that the data in the second state register 3 is one-hot representation data because the number of bits set to “1” is “1” and that there is no error in the second state register 3.

In addition, the error detection processing unit 42 detects that the data in the first state register 2 is “00011” and that the number of bits set to “1” is “2”. Since the number of bits set to “1” in the data of the first state register 2 is not “1”, the error detection processing unit 42 determines that the data is not one-hot representation data and that an error exists in the first state register 2 (detects an error). Since the error detection processing unit 42 has detected that an error exists in the first state register 2 as described above, the error detection processing unit 42 generates an error detection signal Det_err with a value of “1” and then transmits the error detection signal Det_err to the data processing unit DataUA and the control unit CtrUA.

In addition, when the error detection signal Det_err transmitted from the error detection processing unit 42 has a signal value “1” indicating error detection, the data processing unit DataUA performs exception processing or error processing, for example. Note that even if an error has been detected, in a case when error correction processing has been successfully performed, the data processing unit DataUA may perform normal processing (may perform neither exception processing nor error processing).

Further, the control unit CtrUA performs exception processing or error processing when the error detection signal Det_err transmitted from the error detection processing unit 42 has the signal value of “1” indicating an error detection. Note that even if an error has been detected, in a case when error correction processing has been successfully performed, the control unit CtrUA may perform normal processing (may perform neither exception processing nor error processing). Performing the above-described processing allows the data processing device 1000A to take measures such as performing exception processing or stopping a predetermined process upon determining that an abnormal state has occurred.

### Summary of the Embodiment

As described above, in addition to the functions of the data processing device 1000 of the first embodiment, the data processing device 2000 performs error detection when an error is detected in either of the duplicated state registers, so that even if error correction processing has been successful, the data processing device 2000 appropriately detects that an error has occurred in the data of the state register due to a fault attack.

### First Modification

Next, a first modification of the second embodiment will be described. In this modification, only the error detection processing performed by the error detection processing unit 42 differs from the above-described processing performed by the error detection processing unit 42 of the second embodiment.

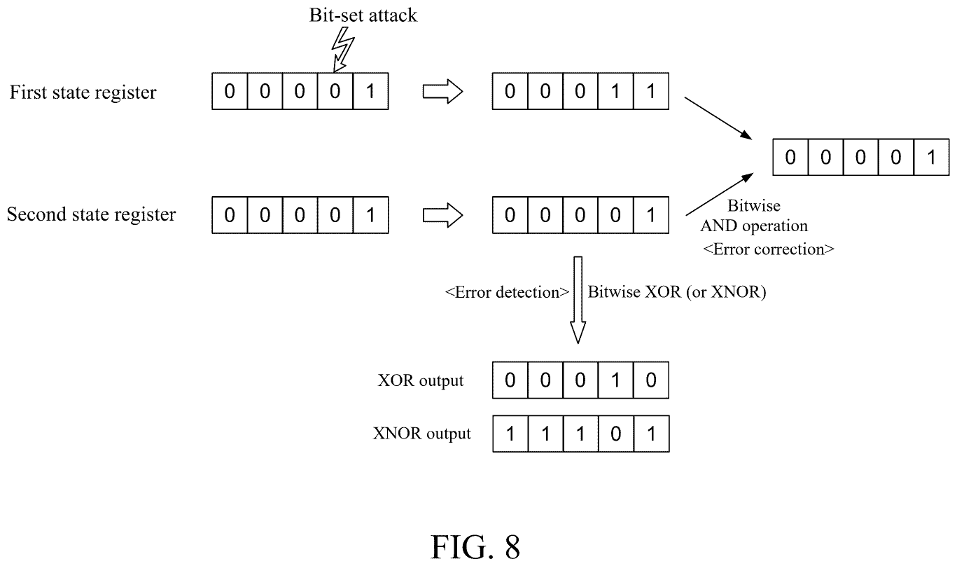

FIG. 8 is a diagram for explaining the error detection processing in the first modification according to the second embodiment.

For example, a case will be described when the state of the data processing device 2000 is in the idle state, and the first state register 2 and the second state register 3 are set to “00001”, in a case where a bit-set attack is performed on the second bit of the first state register 2, as shown in FIG. 8.

In this case, as shown in FIG. 8, the data of the first state register 2 becomes “00011”. The error detection processing unit 42 of the state machine unit 100A performs a bitwise XOR (or XNOR) operation (bit XOR operation processing (or bit XNOR operation processing)) on the data of the first state register 2 (“00011”) and the data of the second state register 3 (“00001”). If the bit XOR operation result data (“00010”) contains any bits with a value of “1”, the error detection processing unit 42 determines that an error has been detected (determines that at least one bit has a different value in the data of the first state register 2 and the second state register 3) and then sets the error detection signal value to “1”. When performing the XNOR operation processing, the error detection processing unit 42 determines that an error has been detected if there is a bit with a value of “0” in the bit XNOR operation result data (“11101”) (determines that at least one bit has a different value in the data of the first state register 2 and the second state register 3), and then sets the value of the error detection signal Det_err to “1”.

The error detection processing unit 42 then transmits the error detection signal Det_err obtained above to the data processing unit DataUA and the control unit CtrUA.

The data processing unit DataUA performs exception processing and/or error processing when the error detection signal Det_err transmitted from the error detection processing unit 42 has a signal value of “1” indicating error detection. Note that even if an error has been detected, the data processing unit DataUA may perform normal processing (may perform neither exception processing nor error processing) in a case when error correction processing has been successfully performed.

In addition, when the error detection signal Det_err transmitted from the error detection processing unit 42 has a signal value “1” indicating error detection (error detection), the control unit CtrUA performs exception processing and/or error processing, for example. This allows the data processing device 1000A to take measures such as performing exception processing or stopping a predetermined process upon determining that an abnormal state has occurred.

As described above, in addition to the functions of the data processing device 1000 of the first embodiment, the data processing device 2000 of the present modification performs error detection even when an error is detected in either of the duplicated state registers, so that even if error correction processing has been successful, the data processing device 2000 appropriately detects that an error has occurred in the data of the state register due to a fault attack.

Note that in the above description, a case has been described in which the data processing device 2000 stores one-hot representation data in the first state register 2 and the second state register 3, and the error correction processing unit 41 performs error correction processing by taking a bitwise AND of the data inputted from the first state register 2 and the second state register 3, and then the error detection processing unit 42 performs error detection processing by obtaining the number of bits that are either “1” or “0”; however, the present invention should not be limited to this case. For example, in a data processing device 2000 that manages states as one-cold representation data, the first state register 2 and the second state register 3 may store one-cold representation data, and the error correction processing unit 41 may perform error correction processing by performing a bitwise OR operation on the data inputted from the first state register 2 and the second state register 3, and then the error detection processing unit 42 may perform error detection processing by obtaining the number of bits that are “0”.

### Third Embodiment

Next, a third embodiment will be described. The same reference numerals are used for the same parts as in the above embodiment (including the modification), and detailed descriptions are omitted.

### 3.1: Configuration of Data Processing Device

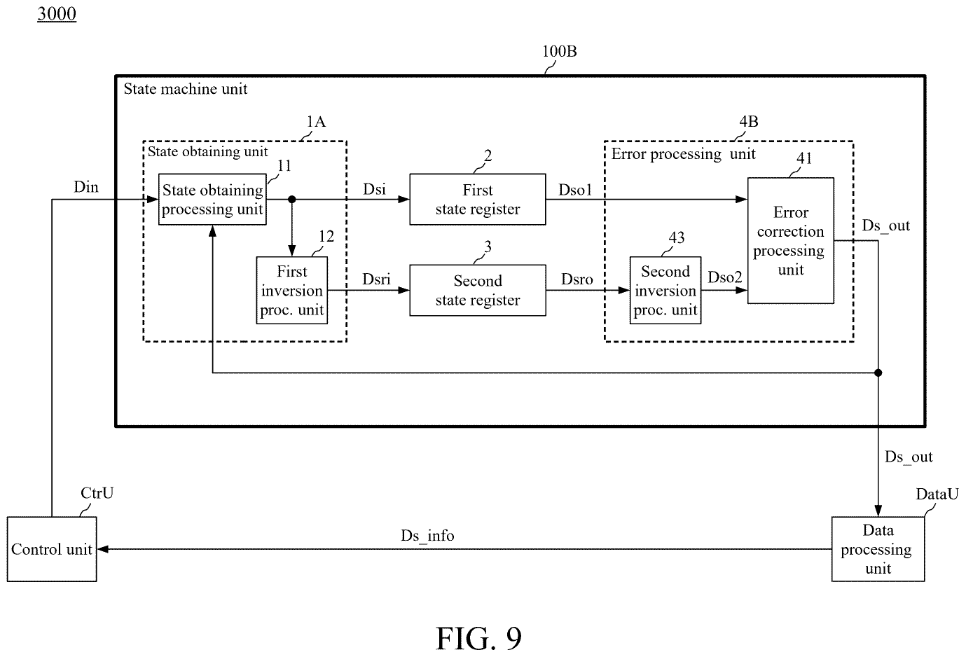

FIG. 9 is a schematic configuration diagram of a data processing device 3000 according to the third embodiment.

The data processing device 3000 of the third embodiment has a configuration in which the state machine unit 100 in the data processing device 1000 of the first embodiment is replaced with a state machine unit 100B, as shown in FIG. 9.

The state machine unit 100B has a configuration in which the state obtaining unit 1 is replaced with a state obtaining unit 1A and the error processing unit 4 is replaced with an error processing unit 4B in the state machine unit 100 of the first embodiment.

The state obtaining unit 1A includes a state obtaining processing unit 11 and a first inversion processing unit 12. The state obtaining processing unit 11 is the same as the state obtaining processing unit 11 in the above embodiment.

The error processing unit 4B includes an error correction processing unit 41 and a second inversion processing unit 43. The error correction processing unit 41 is the same as the error correction processing unit 41 in the above embodiment.

The first inversion processing unit 12 receives data Dsi transmitted from the state obtaining processing unit 11 and performs processing of inverting each bit of the data Dsi (one-hot representation data) (processing of converting one-hot representation data into one-cold representation data), and then transmits the inverted data, as data Dsri (one-cold representation data), to the second state register 3.

The second inversion processing unit 43 receives the data transmitted from the second state register 3 as data Dsro, performs processing of inverting each bit of the received data (one-cold representation data) (processing of converting one-cold representation data into one-hot representation data), and then transmits the inverted data, as data Dso2 (one-hot representation data), to the error correction processing unit 41.

### 3.2: Operation of Data Processing Device

The operation of the data processing device 3000 configured as described above will now be described. Details that are the same as those in the above embodiment (including the modification) are omitted.

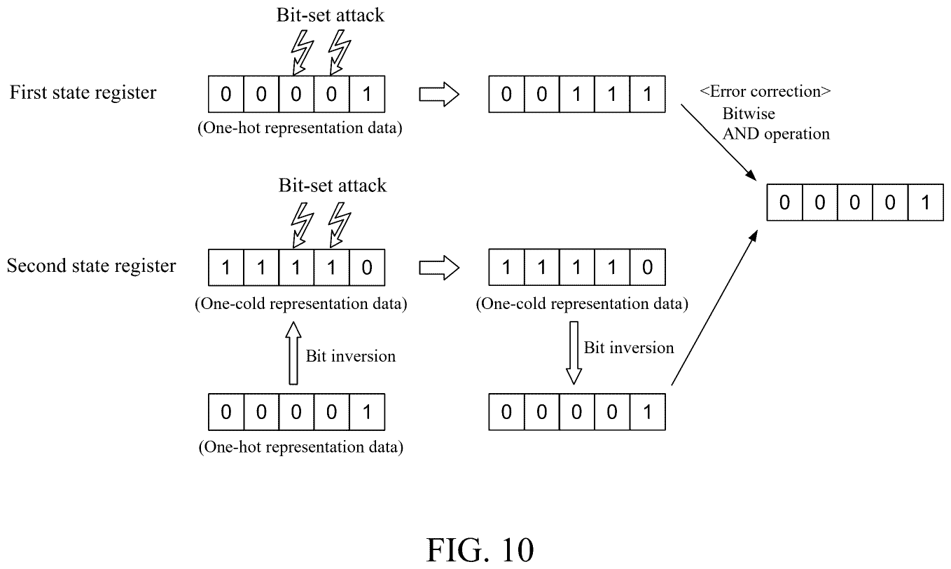

FIG. 10 is a diagram for explaining error detection processing performed by the state machine unit 100B of the data processing device 3000 according to the third embodiment.

In the first embodiment, the data processing device 1000 includes the first state register 2 and the second state register 3, both of which store one-hot representation data, whereas in the third embodiment, the first state register 2 stores one-hot representation data, and the second state register 3 stores one-cold representation data (a data format where only one bit is “0” and all other bits are “1”). This enhances resistance not only to bit-set attacks (attacks that change the value “0” in the register(s) to “1”) but also to bit-reset attacks (attacks that change the value “1” in the register(s) to “0”).

For example, as shown in FIG. 10, a case will be described in which when the state of the data processing device 3000 is in the idle state, the first state register 2 is set to “00001”, the second state register 3 is set to “11110”, a bit-set attack is performed on the second and third bits of the first state register 2, and furthermore a bit-set attack is performed on the second and third bits of the second state register 3. Assuming that the first inversion processing unit 12 inverts the data Dsi (=“00001”) transmitted from the state obtaining processing unit 11, obtains the data Dsri (=“11110”), and then writes this data Dsri to the second state register 3.

When the above bit-set attack is performed, the data in the first state register 2 becomes “00111” as shown in FIG. 10, and the data in the second state register 3 remains “11110”.

The second inversion processing unit 43 receives the data in the second state register 3(=“11110”) as data Dsro, performs bit inversion processing on the received data, obtains the bit-inverted data Dso2 (=“00001”), and then transmits the data Dso2 to the error correction processing unit 41.

The error correction processing unit 41 performs error correction processing by performing a bitwise AND operation (bit AND operation) on the data Dso1 (=“00111”) transmitted from the first state register 2 and the data Dso2 (=“00001”) transmitted from the second inversion processing unit 43, performs bitwise AND processing (bit AND operation processing) in the same manner as in the first embodiment to perform error correction processing, thereby obtaining the error-corrected data Ds_out (=“00001”). The error correction processing unit 41 then transmits the data Ds_out (=“00001”) to the state obtaining unit 1A and the data processing unit DataU.

As shown in FIG. 10, the above processing ensures that the data after error correction is correct data (i.e., “00001”). Even in the case of FIG. 10, even when a fault attack (bit-set attack or bit-reset attack) is performed on multiple bits in the first state register 2 and the second state register 3, the error correction processing enables the retrieval of correct data.

In addition, the state machine unit 100B, as described above, includes (1) a state register (the first state register 2) that stores one-hot representation data with high resistance to bit-reset attacks (attacks that reset bits to “0”) and (2) a state register (the second state register 3) that stores one-cold representation data with high resistance to bit-set attacks, thereby duplicating the state registers. This configuration enables fault attack countermeasure processing with enhanced resistance to both bit-set attacks and bit-reset attacks.

### Summary of the Embodiment

As described above, in the data processing device 3000, the state register is duplicated in the state machine unit 100, (1) one of the state registers (the first state register 2 in the above) is used as a state register for storing one-hot representation data with high resistance to bit reset attacks (attacks that reset bits to “0”), and (2) the other state register (the second state register 3 in the above) is used as a state register for storing one-cold representation data with high resistance to bit-set attacks, thus enabling fault attack countermeasure processing with enhanced resistance to both bit-set attacks and bit-reset attacks. Furthermore, in the data processing device 3000, the output of the state register storing the one-cold representation data is inverted and then is inputted into the error correction processing unit 41, and error correction processing is performed in the same manner as in the first embodiment, thus allowing for performing error correction processing at low cost without requiring large-scale hardware, while achieving high-speed and high-performance data error correction processing.

### Fourth Embodiment

Next, a fourth embodiment will be described. Note that parts identical to those in the above embodiment (including the modification) are indicated by the same symbols, and detailed descriptions are omitted.

In the data processing device of the above embodiment, error correction processing and error detection processing are performed using one-hot representation data or one-cold representation data with duplicated state registers, resulting in a large circuit scale for the required registers. Accordingly, in the data processing device of the fourth embodiment, the state register is provided using a split register, thereby appropriately preventing an increase in the circuit scale of the required registers.

### 4.1: Configuration of Data Processing Device

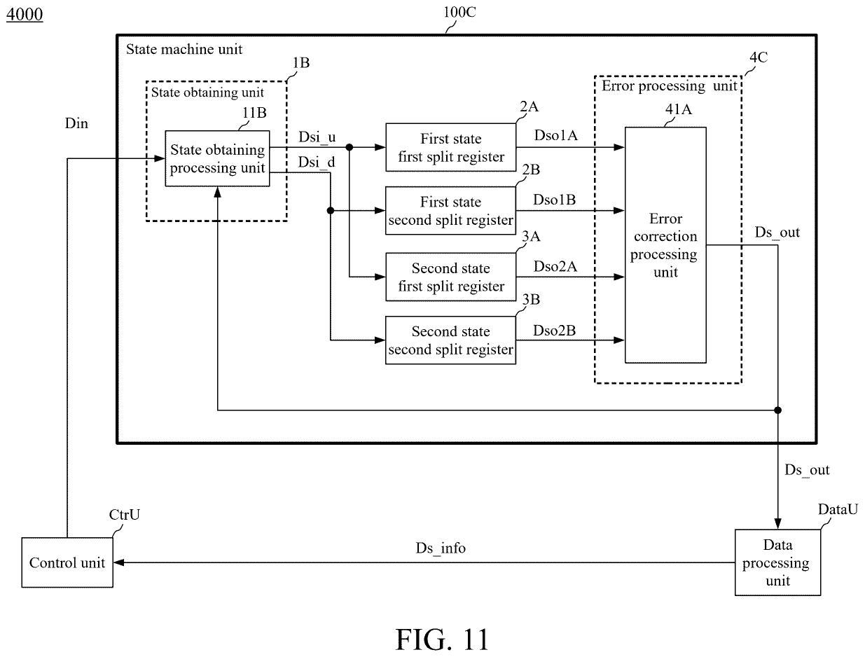

FIG. 11 is a schematic configuration diagram of a data processing device 4000 according to a fourth embodiment.

The data processing device 4000 of the fourth embodiment has a configuration in which the state machine unit 100 in the data processing device 1000 of the first embodiment is replaced with a state machine unit 100C, as shown in FIG. 11. In the data processing device 4000 of the fourth embodiment, the state machine unit 100C uses a split register, which allows the circuit scale of the registers to be reduced even when the number of defined states is large.

The state machine unit 100C has a configuration in which the state obtaining unit 1 is replaced with a state obtaining unit 1B, the error processing unit 4 is replaced with an error processing unit 4C, and furthermore the first state register 2 is replaced with a first state first split register 2A and a first state second split register 2B, and the second state register 3 is replaced with a second state first split register 3A and a second state second split register 3B.

The state obtaining unit 1B has a configuration in which the state obtaining unit 1 is replaced with a state obtaining processing unit 11B.

The error processing unit 4C has a configuration in which the error correction processing unit 41 is replaced with an error correction processing unit 41A.

The state obtaining processing unit 11B receives the state transition control signal Din transmitted from the control unit CtrU and the state indication signal Ds_out transmitted from the error processing unit 4C. The state obtaining processing unit 11B performs processing (state obtaining processing) for obtaining a state to be transitioned to based on the state transition control signal Din and the state indication signal Ds_out, and then obtains data indicating the state obtained by this processing as upper bit data Dsi_u and lower bit data Dsi_d. The state obtaining processing unit 11B (1) transmits (writes) the obtained upper bit data Dsi_u to the first state first split register 2A and the second state first split register 3A, and (2) transmits (writes) the obtained lower bit data Dsi_d to the first state second split register 2B and the second state second split register 3B.

The first state first split register 2A is a register (data storage device) capable of storing and retaining M-bit data (M is a natural number). The first state first split register 2A receives the upper bit data Dsi_u transmitted from the state obtaining processing unit 11B, and stores and retains the data. Further, the first state first split register 2A transmits the data stored therein as data Dso1A to the error correction processing unit 41A one cycle after the timing when the data has been received (one clock cycle later).

The first state second split register 2B is a register (data storage device) capable of storing and retaining M′-bit data (M′ is a natural number; M′ may be equal to M, or may be different from M) (For the sake of explanation, a case of M′=M will be described below). The first state second split register 2B receives the lower bit data Dsi_d transmitted from the state obtaining processing unit 11B and stores the data. Further, the first state second split register 2B transmits the data stored therein as data Dso1B to the error correction processing unit 41A one cycle after the timing when the data has been received (one clock cycle later).

The second state first split register 3A is a register (data storage device) capable of storing and retaining M-bit data (M is a natural number). The second state first split register 3A receives the upper bit data Dsi_u transmitted from the state obtaining processing unit 11B and stores and retains the data. Further, the second state first split register 3A transmits the data stored therein as data Dso2A to the error correction processing unit 41A one cycle after the timing when the data has been received (one clock cycle later).

The second state second split register 3B is a register (data storage device) capable of storing and retaining M′-bit data (M′ is a natural number; M′ may be equal to M, or may be different from M). The second state second split register 3B receives the lower bit data Dsi_d transmitted from the state obtaining processing unit 11B and stores the data. Further, the second state second split register 3B transmits the data stored therein as data Dso2B to the error correction processing unit 41A one cycle after the timing when the data has been received (one clock cycle later).

The error correction processing unit 41A receives (1) the data Dso1A transmitted from the first state first split register 2A, (2) the data Dso1B transmitted from the first state second split register 2B, (3) the data Dso2A transmitted from the second state first split register 3A, (4) the data Dso2B transmitted from the second state second split register 3B.

The error correction processing unit 41A then performs error correction processing using the received data Dso1A and data Dso2A, obtains data after the processing as data Dso_out.u, and (2) performs error correction processing using the received data Dso1B and data Dso2B, and obtains data after the processing as data Ds_out.d.

The error correction processing unit 41A then transmits the data including the obtained data Ds_out.u and data Ds_out.d as data Ds_out (={Ds_out.u, Ds_out.d}) to the state obtaining unit 1B and the data processing unit DataU.

### 4.2: Operation of Data Processing Device

The operation of the data processing device 4000 configured as described above will now be described. Details that are the same as those in the above embodiment (including the modification) are omitted.

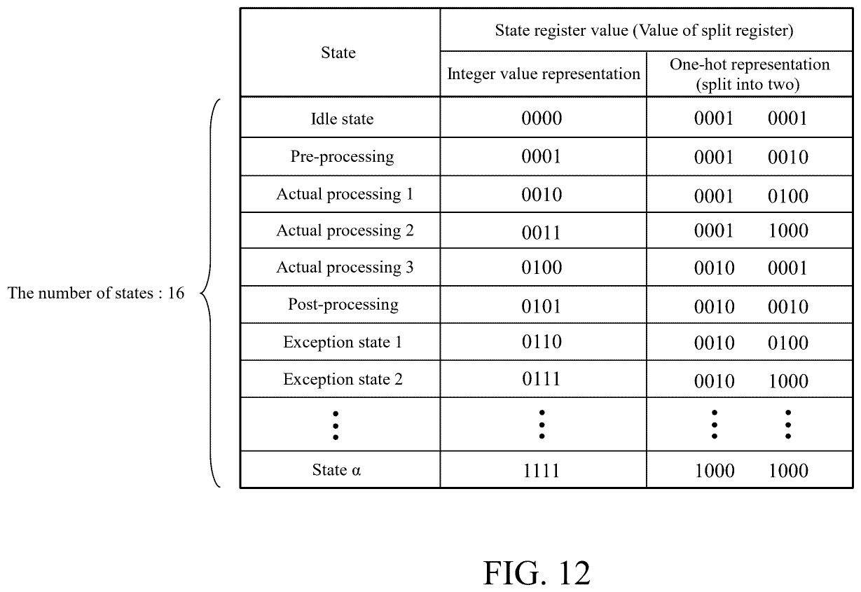

FIG. 12 is a diagram showing a table indicating the relationship between the state of the data processing device 4000 according to the fourth embodiment and the values of the state registers (values of the split registers).

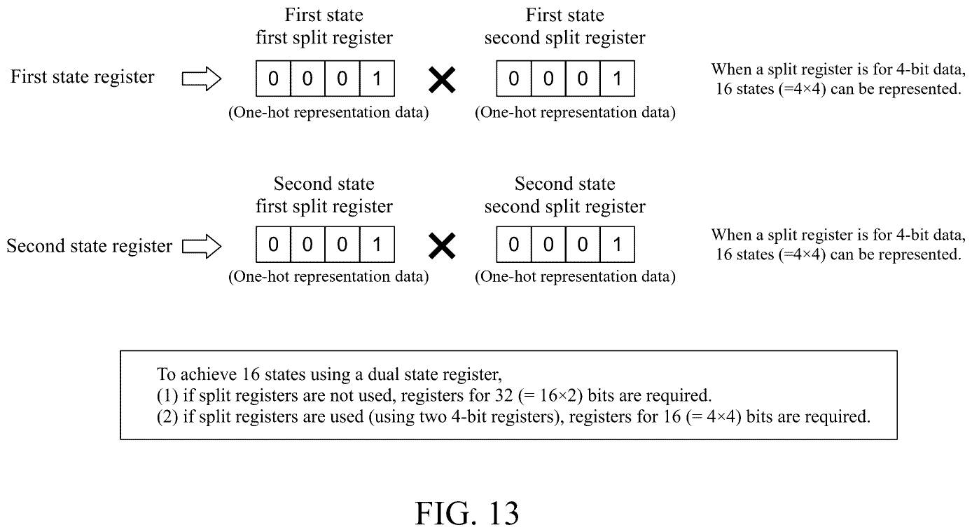

FIG. 13 is a diagram for explaining the split registers of the data processing device 4000 according to the fourth embodiment.

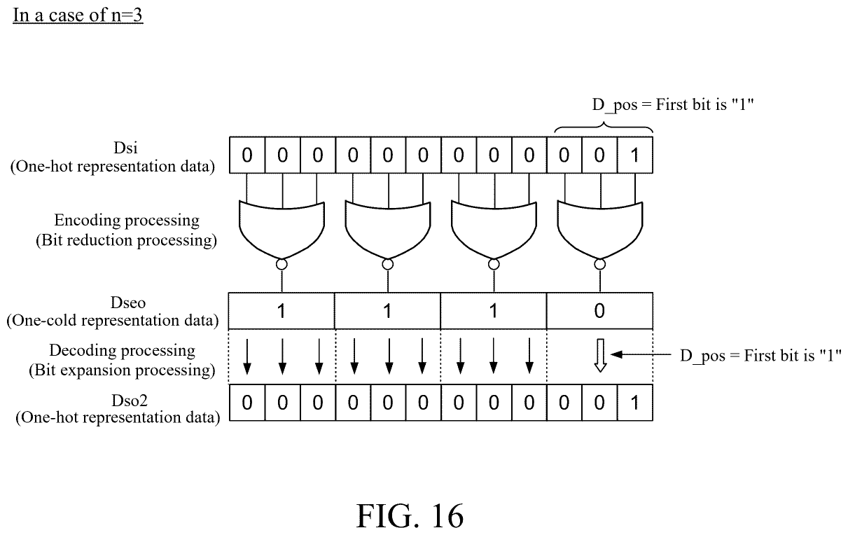

For convenience of explanation, in the data processing device 4000, as shown in FIGS. 12, 16 states are defined, and further the values of the split registers (registers obtained by dividing the state registers into two) for each state are defined. Further, the number of bits of data stored in each split register is set to “4”, and the data stored in each split register is assumed to be one-hot representation data.

The state obtaining processing unit 11B performs processing (state obtaining processing) for obtaining a state to be transitioned to based on the state transition control signal Din transmitted from the control unit CtrU and the state indication signal Ds_out transmitted from the error correction processing unit 41A, and obtains data indicating the state obtained by this processing as the upper bit data Dsi_u and the lower bit data Dsi_d. The state obtaining processing unit 11B (1) transmits (writes) the obtained upper bit data Dsi_u to the first state first split register 2A and the second state first split register 3A, and (2) transmits (writes) the obtained lower bit data Dsi_d to the first state second split register 2B and the second state second split register 3B.

The first state first split register 2A receives the upper bit data Dsi_u transmitted from the state obtaining processing unit 11B and stores the data therein.

The first state second split register 2B receives the lower bit data Dsi_d transmitted from the state obtaining processing unit 11B and stores the data therein.

The second state first split register 3A receives the upper bit data Dsi_u transmitted from the state obtaining processing unit 11B and stores the data therein.

The second state second split register 3B receives the lower bit data Dsi_d transmitted from the state obtaining processing unit 11B and stores the data therein.

The error correction processing unit 41A receives (1) the data Dso1A transmitted from the first state first split register 2A, (2) the data Dso1B transmitted from the first state second split register 2B, (3) the data Dso2A transmitted from the second state first split register 3A, and (4) the data Dso2B transmitted from the second state second split register 3B.

The error correction processing unit 41A then performs error correction processing using the received data Dso1A and Dso2A and obtains data after the processing as data Dso_out.u, and (2) performs error correction processing using the received data Dso1B and Dso2B and obtains data after the processing as data Dso_out.d.

Specifically, the error correction processing unit 41A performs the following operations:
Ds_out.u=AND(Dso1A, Dso2A)

AND(x, y): A function for obtaining data that has been obtained by performing a bitwise AND operation (AND operation on the same bit positions) between binary data x and binary data y (a function for obtaining data that has been obtained by performing a bitwise AND operation between two data), and obtains the data Ds_out.u after the processing.

In addition, the error correction processing unit 41A performs the following operations:
Ds_out.d=AND(Dso1B, Dso2B)

AND(x, y): A function for obtaining data that has been obtained by performing a bitwise AND operation (AND operation on the same bit positions) between binary data x and binary data y (a function for obtaining data that has been obtained by performing a bitwise AND operation between two data), and obtains the data Ds_out.d after the processing.

The error correction processing unit 41A transmits the data including the obtained data Ds_out.u and the data Ds_out.d as data Ds_out (={Ds_out.u, Ds_out.d}) to the state obtaining unit 1B and the data processing unit DataU.

Performing the above processing in the data processing device 4000, in which one-hot representation data is adopted and duplicated state registers are provided by means of split registers, allows for performing high-speed, high-performance data error correction processing while appropriately preventing an increase in the circuit scale of the required registers, even when the number of states handled by the data processing device 4000 is large (in the above case, the number of states is “16”).

For example, when the number of states handled by a data processing device is “16”, the duplicated state registers (the first state register 2 and the second state register 3) of the data processing device 1000 of the first embodiment require 32 bits of register space (32 =16 bits×2) in handling one-hot representation data, whereas the data processing device 4000 of the present embodiment requires only 16 bits of register space (16 =4 bits×4) because split registers are used as shown in FIG. 13.

### Summary of the Embodiment

As described above, the data processing device 4000, in which each of the duplicated state registers is provided by using a split register and one-hot representation data is adopted, allows for performing high-speed, high-performance data error correction processing while appropriately preventing an increase in the circuit scale of the required registers, even when the number of states handled by the data processing device 4000 is large.

In the above description, a case has been described in which in the data processing device 4000, one-hot representation data is stored in the first state first split register 2A, the first state second split register 2B, the second state first split register 3A, and the second state second split register 3B, and the error correction processing unit 41A performs a bitwise AND operation on the data inputted from the above registers to perform error correction processing; however, the present invention should not be limited to this configuration. For example, in the data processing device 4000 that manages states as one-cold representation data, one-cold representation data may be stored in the first state first split register 2A, the first state second split register 2B, the second state first split register 3A, and the second state second split register 3B, and the error correction processing unit 41A may perform error correction processing by performing a bitwise OR operation on the data inputted from the above registers.

Further, in the data processing device 4000, the one-hot representation data may be stored in the first state first split register 2A and the first state second split register 2B, and the one-cold representation data may be stored in the second state first split register 3A and the second state second split register 3B, and error correction processing may be performed.

### Fifth Embodiment

Next, a fifth embodiment will be described. The same reference numerals are used for the same parts as in the above embodiments (including the modification), and detailed descriptions are omitted.

### 5.1: Configuration of Data Processing Device

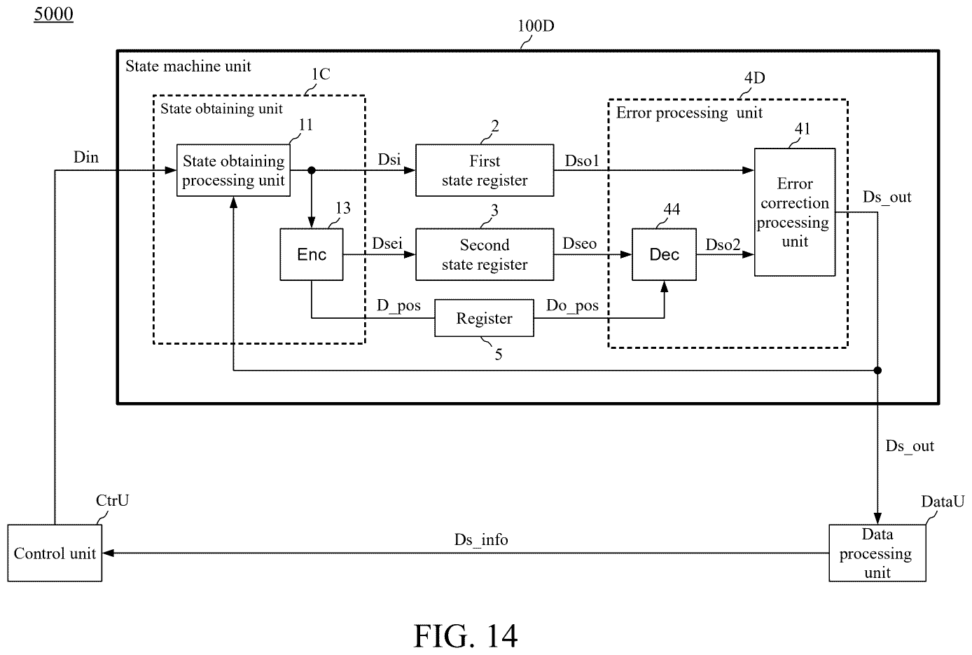

FIG. 14 is a schematic configuration diagram of a data processing device 5000 according to the fifth embodiment.

The data processing device 5000 of the fifth embodiment has a configuration in which the state machine unit 100B in the data processing device 3000 of the third embodiment is replaced with a state machine unit 100D, as shown in FIG. 14.

The state machine unit 100D has a configuration in which the state obtaining unit 1A is replaced with a state obtaining unit 1C, the error processing unit 4B is replaced with an error processing unit 4D, and a register 5 is added in the state machine unit 100B of the third embodiment.

The state obtaining unit 1C includes a state obtaining processing unit 11 and an encoding unit 13.

The error processing unit 4D includes an error correction processing unit 41 and a decoding unit 44.

The encoding unit 13 receives the data Dsi (one-hot representation data) transmitted from the state obtaining processing unit 11 and obtains one-cold representation data with reduced bits by performing NOR logic on the data Dsi for every n bits (n is a natural number of two or more). Further, the encoding unit 13 obtains, as data D_pos, data indicating the position where the bit of data Dsi (one-hot representation data) is “1” within an n-bit area, which is a unit of NOR logic. The encoding unit 13 then transmits (writes) the bit-reduced one-cold representation data obtained above, as data Dsei, to the second state register 3. Also, the encoding unit 13 transmits the data D_pos to the register 5 at the same time as transmitting the data Dsei to the second state register 3.

The register 5 is a register (data storage device) capable of storing and retaining data. The register 5 receives the data D_pos transmitted from the encoding unit 13 and stores it. Additionally, the register 5 transmits the stored data as data D_pos to the decoding unit 44.

The decoding unit 44 receives the data Dseo from the second state register 3 and the data Do_pos from the register 5. The decoding unit 44 obtains the data Do_pos from the register 5 at the same timing when obtaining the data Dseo from the second state register 3. The decoding unit 44 performs processing of inverting each bit of the received data (bit-reduced one-cold representation data) (processing of converting one-cold representation data into one-hot representation data), and then performs bit expansion processing while taking into account the data Do_pos transmitted from the register 5, thereby obtaining the decoded data. The decoding unit 44 then transmits the decoded data as data Dso2 (one-hot representation data) to the error correction processing unit 41.

### 5.2: Operation of Data Processing Device

The operation of the data processing device 5000 configured as described above will now be described. Details that are the same as those in the above embodiment (including the modification) are omitted.

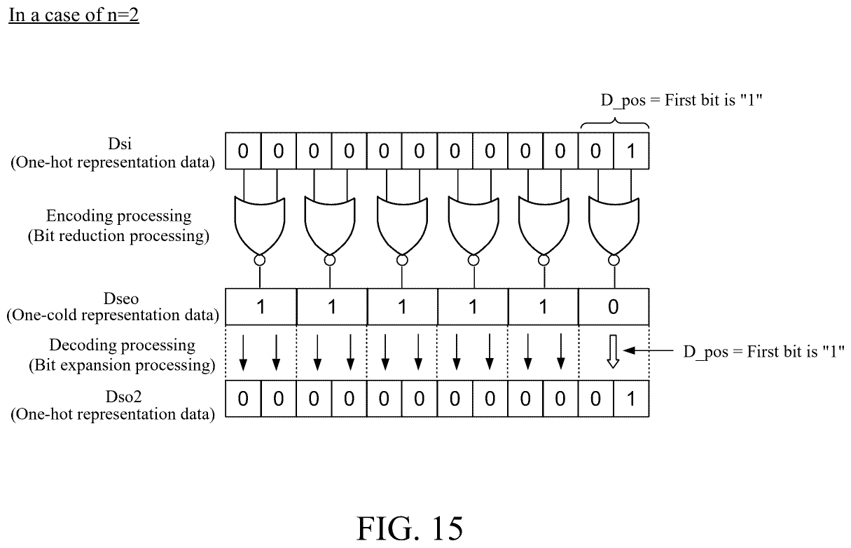

FIG. 15 is a diagram for explaining encoding processing (bit reduction processing) and decoding processing (bit expansion processing) performed by the state machine unit 100D of the data processing device 5000 according to the fifth embodiment (in a case of n=2).

FIG. 16 is a diagram for explaining encoding processing (bit reduction processing) and decoding processing (bit expansion processing) performed by the state machine unit 100D of the data processing device 5000 according to the fifth embodiment (in a case of n=3).

For example, as shown in FIGS. 15 and 16, when the state of the data processing device 5000 is in the idle state and the data Dsi transmitted from the state obtaining processing unit 11 is “000000000001” (12-bit data), the encoding unit 13 performs NOR logic on the data Dsi transmitted from the state obtaining processing unit 11 for every n bits (n is a natural number greater than or equal to 2) to obtain bit-reduced one-cold representation data (6-bit data in the case of FIG. 15; 4-bit data in the case of FIG. 16)(n=2 for the case of FIG. 15; n=3 for the case of FIG. 16).

In addition, the encoding unit 13 obtains, as the data D_pos, data indicating the position where the bit of the data Dsi (one-hot representation data) is “1” within an n-bit area, which is a unit of NOR logic. In the case of FIGS. 15 and 16, the first bit of the data Dsi is “1”, and thus the data D_pos is obtained as data indicating that the first bit is “1”.

The encoding unit 13 transmits (writes) the bit-reduced one-cold representation data obtained above as data Dsei to the second state register 3. In addition, the encoding unit 13 transmits the data D_pos obtained above to the register 5.

The decoding unit 44 receives the data Dseo (bit-reduced one-cold representation data) transmitted from the second state register 3, performs processing of inverting each bit of the received data (processing of converting one-cold representation data into one-hot representation data), furthermore, while considering the data Do_pos transmitted from the register 5, performs bit expansion processing to obtain decoded data Dso2 (one-hot representation data). In the case of FIG. 15, the bits other than the first bit (the second to sixth bits) of the bit-reduced data Dseo are “1”, and thus the third to twelfth bits of the decoded data Dso2 are set to “0” (the inverted data of “1”).

In the case of FIG. 16, the bits other than the first bit (the second to fourth bits) of the bit-reduced data Dseo are “1”, and thus the fourth to twelfth bits of the decoded data Dso2 are set to “0” (the inverted data of “1”). Since the first bit of the bit-reduced data Dseo is “0”, bit expansion processing is performed by referring to the data Do_pos transmitted from the register 5. In the case of FIGS. 15 and 16, since the data Do_pos indicates that the first bit of the data Dsi is “1”, the first bit of the decoded data Dso2 is set to “1” and the second and third bits are set to “0”, thereby performing the decoding processing (bit expansion processing).

The decoding unit 44 then transmits the decoded data Dso2 obtained by the above processing to the error correction processing unit 41.

As described above, in the data processing device 5000, similar to the data processing device 3000 of the third embodiment, a state register for storing one-hot representation data and a state register for storing one-cold representation data are used to duplicate the state registers, furthermore, the encoding unit 13 performs encoding processing (bit-reduction processing) and stores the one-cold representation data into the state register (the second state register 3 in the present embodiment), thereby reducing the circuit scale of the state registers.

In the data processing device 5000, as described above, the encoding processing performed by the encoding unit 13 is processing of obtaining bit-reduced one-cold representation data by taking NOR logic in n bits (n is a natural number of two or more), and the decoding processing performed by the decoding unit 44 is processing of performing bit inversion processing and bit expansion processing; however, the present invention should not be limited to this. In the data processing device 5000, the encoding processing performed by the encoding unit 13 and the decoding processing performed by the decoding unit 44 may also be performed as the following processes.
(1) The encoding processing performed by the encoding unit 13 is processing of obtaining bit-reduced one-hot representation data by performing OR logic on data for every n bits (n is a natural number of two or more), and the decoding processing performed by the decoding unit 44 is processing of performing bit expansion processing.
(2) (For example, in a data processing device 5000 that manages states as one-cold representation data) The data inputted into the encoding unit 13 is one-cold representation data, the encoding processing performed by the encoding unit 13 is processing of obtaining bit-reduced one-cold representation data by performing AND logic on data for every n bits (n is a natural number of two or more), and the decoding processing performed by the decoding unit 44 is processing of performing bit expansion processing.
(3) (For example, in a data processing device 5000 that manages states as one-cold representation data) The data inputted into the encoding unit 13 is one-cold representation data, the encoding processing performed by the encoding unit 13 is processing of obtaining bit-reduced one-hot representation data by performing NAND logic on data for every n bits (n is a natural number of two or more), and the decoding processing performed by the decoding unit 44 is processing of performing bit inversion processing and bit expansion processing.

### Sixth Embodiment

Next, the sixth embodiment will be described. Note that the same reference numerals are used for the same parts as in the above embodiments (including the modification), and detailed descriptions are omitted.

### 6.1: Configuration of Data Processing Device

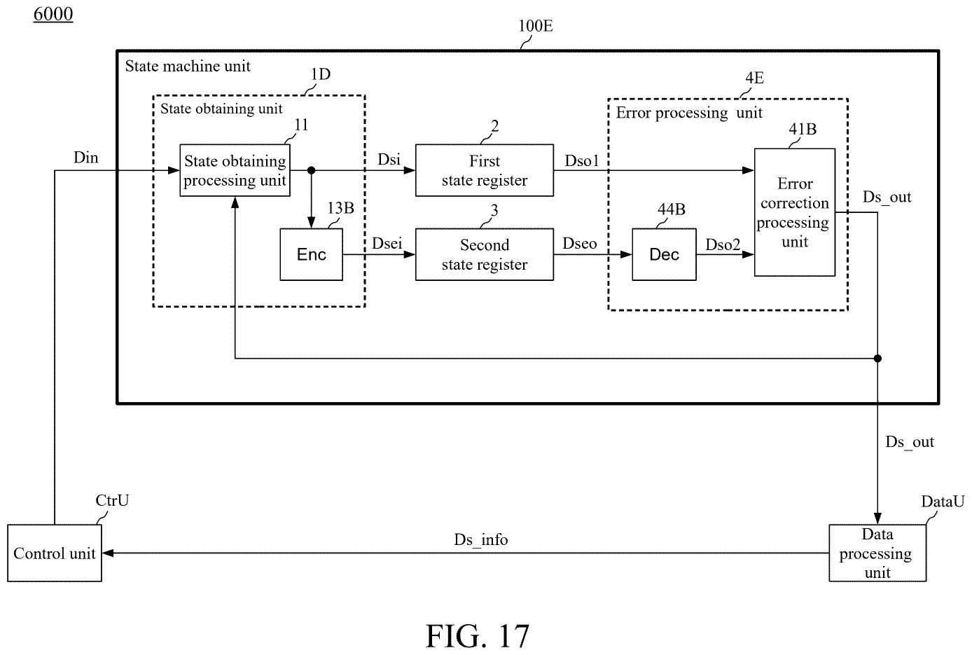

FIG. 17 is a schematic configuration diagram of a data processing device 6000 according to a sixth embodiment.

The data processing device 6000 of the sixth embodiment has a configuration in which the state machine unit 100D is replaced with a state machine unit 100E in the data processing device 5000 of the fifth embodiment, as shown in FIG. 17.

The state machine unit 100E has a configuration in which the state obtaining unit 1C is replaced with a state obtaining unit 1D and the error processing unit 4D is replaced with an error processing unit 4E in the state machine unit 100D of the fifth embodiment.

The state obtaining unit 1D includes a state obtaining processing unit 11 and an encoding unit 13B.

The error processing unit 4E includes an error correction processing unit 41 and a decoding unit 44B.

The encoding unit 13B receives the data Dsi (one-hot representation data) transmitted from the state obtaining processing unit 11 and obtains bit-reduced one-cold representation data by performing NOR logic on the data Dsi for every n bits (n is a natural number of two or more). The encoding unit 13 then transmits (writes) the bit-reduced one-cold representation data obtained above as data Dsei to the second state register 3.

The decoding unit 44B receives the data Dseo (bit-reduced one-cold representation data) from the second state register 3, performs processing of inverting each bit of the received data (processing of converting one-cold representation data to one-hot representation data), and further performs bit expansion processing to obtain the decoded data. The decoding unit 44B transmits the decoded data as data Dso2 (one-hot representation data) to the error correction processing unit 41B.

The error correction processing unit 41B receives the data Dso1 transmitted from the first state register 2 and the data Dso2 transmitted from the decoding unit 44B. The error correction processing unit 41B then performs error correction processing using the received data Dso1 and Dso2, and transmits data after the processing as data Dso_out to the state obtaining unit 1D and the data processing unit DataU.

### 6.2: Operation of Data Processing Device

The operation of the data processing device 6000 configured as described above will now be described. Details that are the same as those in the above embodiment (including the modification) are omitted.

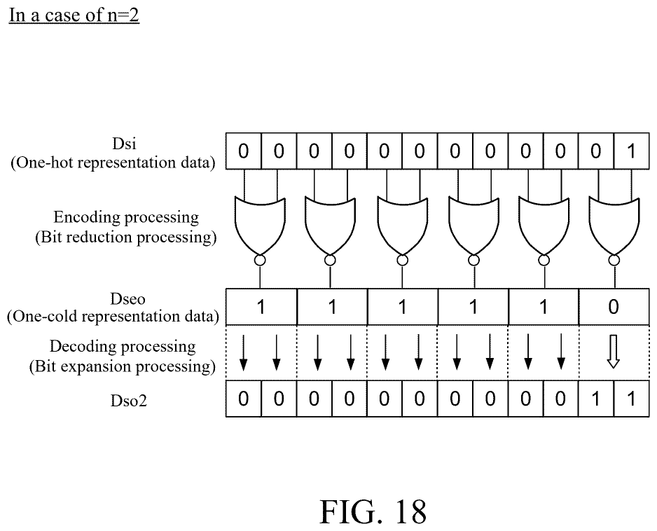

FIG. 18 is a diagram for explaining encoding processing (bit reduction processing) and decoding processing (bit expansion processing) performed by the state machine unit 100E of the data processing device 6000 according to the sixth embodiment (in a case of n=2).

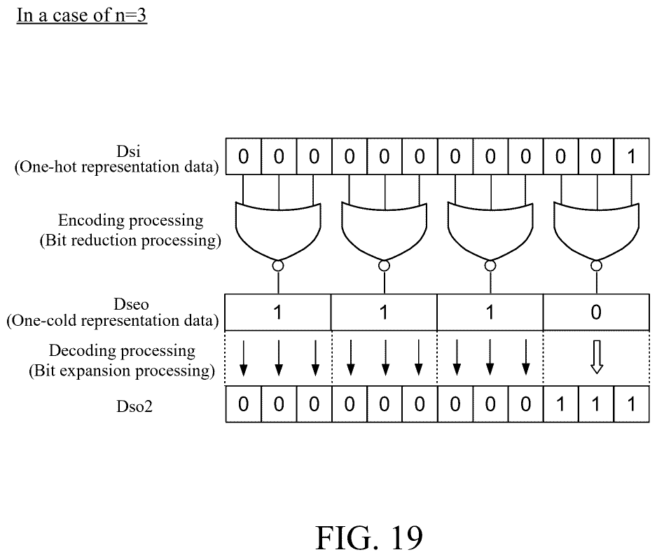

FIG. 19 is a diagram for explaining encoding processing (bit reduction processing) and decoding processing (bit expansion processing) performed by the state machine unit 100E of the data processing device 6000 according to the sixth embodiment (in a case of n=3).

For example, as shown in FIGS. 18 and 19, when the state of the data processing device 6000 is in the idle state and the data Dsi transmitted from the state obtaining processing unit 11 is “000000000001” (12-bit data), the encoding unit 13B performs NOR logic on the data Dsi transmitted from the state obtaining processing unit 11 for every n bits (n is a natural number greater than or equal to 2) to obtain bit-reduced one-cold representation data (6-bit data in the case of FIG. 18; 4-bit data in the case of FIG. 19)(n=2 for the case of FIG. 18; n=3 for the case of FIG. 19).

The encoding unit 13B transmits (writes) the bit-reduced one-cold representation data obtained above as data Dsei to the second state register 3.

The decoding unit 44B receives the data Dseo (bit-reduced one-cold representation data) transmitted from the second state register 3, performs processing of inverting each bit of the received data (processing of converting one-cold representation data into one-hot representation data), furthermore, performs bit expansion processing to obtain decoded data Dso2 (one-hot representation data). In the case of FIG. 18, the bits other than the first bit (the second to sixth bits) of the bit-reduced data Dseo are “1”, and thus the third to twelfth bits of the decoded data Dseo are set to “0” (the inverted data of “1”). In the case of FIG. 19, the bits other than the first bit (the second to forth bits) of the bit-reduced data Dseo are “1”, and thus the fourth to twelfth bits of the decoded data Dseo are set to “0” (the inverted data of “1”). Since the first bit of the bit-reduced data Dseo is “0”, bit expansion processing is performed. In the case of FIG. 18, the decoding processing (bit expansion processing) is performed by setting the first and second bits of the decoded data Dso2 to “1”. In the case of FIG. 19, the decoding processing (bit expansion processing) is performed by setting the first to third bits of the decoded data Dso2 to “1”.

The decoding unit 44B then transmits the decoded data Dso2 obtained by the above processing to the error correction processing unit 41B.

The error correction processing unit 41B performs error correction processing using the data Dso1 transmitted from the first state register 2 and the data Dso2 transmitted from the decoding unit 44B, and then transmits data after the processing as data Dso_out to the state obtaining unit 1D and the data processing unit DataU. Note that the error correction processing unit 41B determines that error correction processing has succeeded (or that there has been no error) if any bit in the data Dso1 is “1” within the range where multiple bits in the data Dso2 are “1”.

As described above, in the data processing device 6000, similar to the data processing device 3000 of the third embodiment, a state register for storing one-hot representation data and a state register for storing one-cold representation data are used to duplicate the state registers, furthermore, the encoding unit 13B performs encoding processing (bit-reduction processing) and stores the one-cold representation data into the state register (the second state register 3 in the present embodiment), thereby reducing the circuit scale of the state registers.

In the data processing device 6000, as described above, the encoding processing performed by the encoding unit 13B is processing of obtaining bit-reduced one-cold representation data by performing NOR logic on data for every n bits (n is a natural number of two or more), and the decoding processing performed by the decoding unit 44B is processing of performing bit inversion processing and bit expansion processing; however, the present invention should not be limited to this. In the data processing device 6000, the encoding processing performed by the encoding unit 13B and the decoding processing performed by the decoding unit 44B may also be performed as the following processes.
(1) The encoding processing performed by the encoding unit 13B is processing of obtaining bit-reduced one-hot representation data by performing OR logic on data for every n bits (n is a natural number of two or more), and the decoding processing performed by the decoding unit 44B is processing of performing bit expansion processing.
(2) (For example, in a data processing device 6000 that manages states as one-cold representation data) The data inputted into the encoding unit 13B is one-cold representation data, the encoding processing performed by the encoding unit 13B is processing of obtaining bit-reduced one-cold representation data by performing AND logic on data for every n bits (n is a natural number of two or more), and the decoding processing performed by the decoding unit 44B is processing of performing bit expansion processing.
(3) (For example, in a data processing device 6000 that manages states as one-cold representation data) The data inputted into the encoding unit 13B is one-cold representation data, the encoding processing performed by the encoding unit 13B is processing of obtaining bit-reduced one-hot representation data by performing NAND logic on data for every n bits (n is a natural number of two or more), and the decoding processing performed by the decoding unit 44B is processing of performing bit inversion processing and bit expansion processing.

### Other Embodiments

A data processing device, a state machine unit, or the like may be configured by combining some or all of the above embodiments and modifications. For example, in the data processing devices 3000, 4000, 5000, and 6000 of the third embodiment, an error detection processing unit may be added to provide an error detection function, similar to the error detection processing unit of the data processing device 2000 of the second embodiment.

Each block of the state machine unit, the data processing device, and the control device in the above embodiments may be formed using a single chip with a semiconductor device, such as LSI, or some or all of the blocks of the state machine unit, the data processing device, and the control device may be formed using a single chip. Further, each block (each functional unit) of the state machine unit, the data processing device, and the control device described in the above embodiments may be implemented with a semiconductor device such as a plurality of LSIs.

Note that although the term LSI is used here, it may also be called IC, system LSI, super LSI, or ultra LSI depending on the degree of integration.

Further, the method of circuit integration should not be limited to LSI, and it may be implemented with a dedicated circuit or a general-purpose processor.

A field programmable gate array (FPGA) that can be programmed after the LSI is manufactured, or a reconfigurable processor that can reconfigure connection and setting of circuit cells inside the LSI may be used.

Further, a part or all of the processing of each functional block of each of the above embodiments may be implemented with a program. A part or all of the processing of each functional block of each of the above-described embodiments is then performed by a central processing unit (CPU) in a computer. The programs for these processes may be stored in a storage device, such as a hard disk or a ROM, and may be executed from the ROM or be read into a RAM and then executed.

The processes described in the above embodiment may be implemented by using either hardware or software (including use of an operating system (OS), middleware, or a predetermined library), or may be implemented using both software and hardware.

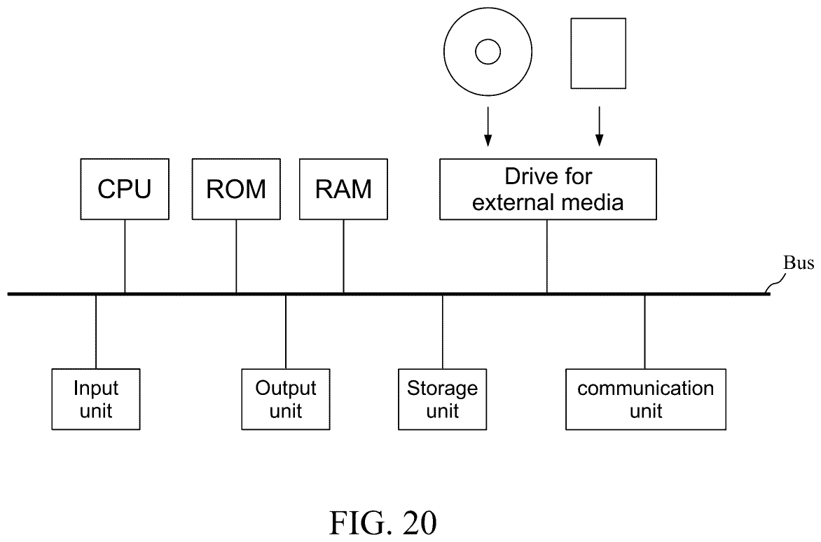

For example, when functional units of the above embodiments and modifications is achieved by using software, the hardware structure (the hardware structure including CPU, GPU, a processor, ROM, RAM, a memory, an input unit, an output unit or the like, each of which is connected to a bus) shown in FIG. 20 may be employed to achieve the functional units by using software.

When each functional unit of the above embodiments is achieved by using software, the software may be achieved by using a single computer having the hardware configuration shown in FIG. 20, and may be achieved by using distributed processes using a plurality of computers.

The processes described in the above embodiment may not be performed in the order specified in the above embodiment. The order in which the processes are performed may be changed without departing from the scope and the spirit of the invention. Further, in the processing method in the above-described embodiments, some steps may be performed in parallel with other steps without departing from the scope and the spirit of the invention. In addition, in the processing method(s) in the above embodiments, the processing performed in parallel may be performed in series (sequentially).

The present invention may also include a computer program enabling a computer to implement the method described in the above embodiment and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program should not be limited to one recorded on the recording medium, but may be transmitted via an electric communication line, a wireless or wired communication line, a network represented by the Internet, or the like.

The term “unit” may include “circuitry,” which may be partly or entirely implemented by using either hardware or software, or both hardware and software.

The functionality of the elements disclosed herein may be implemented using circuitry or processing circuitry which includes general purpose processors, special purpose processors, integrated circuits, ASICs (Application Specific Integrated Circuits), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality.

When the hardware is a processor which may be considered a type of circuitry, the circuitry, means, or units are a combination of hardware and software, the software being used to configure the hardware and/or processor.

The specific structures described in the above embodiment are mere examples of the present invention, and may be changed and modified variously without departing from the scope and the spirit of the invention.

### Appendixes

The present invention can also be achieved as follows.

A first aspect of the present invention provides a data processing device for controlling data processing by transitioning between a finite number of defined states, the data processing device including a first register, a second register, state obtaining circuitry, and error processing circuitry.

The first register is a register capable of storing and retaining data.

The second register is a register capable of storing and retaining data.

The state obtaining circuitry includes a state obtaining processing circuitry that receives a state transition control signal, determines a next state to be transitioned to based on a current state and the state transition control signal, obtains one-hot representation data or one-cold representation data representing the determined state. The state obtaining circuitry transmits the one-hot representation data or the one-cold representation data to the first register and the second register.

The error processing circuitry includes an error correction processing circuitry that receives data stored in the first register as first data, receives data stored in the second register as second data, performs error correction processing based on the first data and the second data to obtain data after error correction processing.

In this data processing device, the data to be written to the state registers is one-hot representation data, and the data processing device includes a first register and a second register, thus providing a configuration in which the state register is duplicated. Further, the data processing device performs error correction processing by performing correction processing (e.g., bitwise AND operation processing) on the data in the first register and the data in the second register, which are the duplicated state registers.

In other words, in this data processing device, one-hot representation data is adopted as the data to be written to a state register, and simple processing (e.g., bit AND operation processing) between the data in the duplicated state registers is performed, allowing error correction processing to be performed. This allows for low-cost implementation without requiring large-scale hardware, while also achieving high-performance data error correction processing. Furthermore, in the data processing device, since only simple processing (e.g., bit AND operations) is performed between the data in the duplicated state registers (between one-hot representation data), high-speed processing can be achieved.

A second aspect of the present invention provides the data processing device of the first aspect of the present invention in which the error correction processing circuitry performs the error correction processing by performing an AND operation on the bits at the same bit positions of the first data and the second data.

This allows the state machine circuitry to perform error correction processing simply by performing bit AND operations.

A third aspect of the present invention provides the data processing device of the first or second aspect of the present invention in which the error processing circuitry further comprising error detection processing circuitry that performs error detection processing on data stored in the first register and data stored in the second register, and obtains result data of the error detection processing as error detection data.

This allows the data processing device to perform error detection processing in addition to error correction processing. In this data processing device, error detection can be performed when an error occurs in either of the duplicated state registers, so that even if error correction processing has been successful, it is possible to appropriately detect that an error has occurred in the data of the state register due to a fault attack.

A fourth aspect of the present invention provides the data processing device of any one of the first to third aspects of the present invention in which the state obtaining circuitry further includes first inversion processing circuitry, and the error processing circuitry further includes second inversion processing circuitry.

The state obtaining processing circuitry receives a state transition control signal, determines a next state to be transitioned to based on a current state and the state transition control signal, obtains first state data, which is one-hot representation data representing the determined state, and transmits the obtained first state data to the first register.

The first inversion processing circuitry performs bit inversion processing on the first state data to obtain second state data, which is one-cold representation data, and transmits the obtained second state data to the second register.

The second inversion processing circuitry receives data stored in the second register, and performs bit inversion processing on the received data to obtain third state data.

The error correction processing circuitry performs error correction processing on data stored in the first register and the third state data to obtain data after error correction processing.

In this data processing device, the state register is duplicated, (1) one of the state registers (e.g., first state register) is used as a state register for storing one-hot representation data with high resistance to bit reset attacks (attacks that reset bits to “0”), and (2) the other state register (e.g., second state register) is used as a state register for storing one-cold representation data with high resistance to bit-set attacks, thus enabling fault attack countermeasure processing with enhanced resistance to both bit-set attacks and bit-reset attacks. Furthermore, in the data processing device, the output of the state register storing the one-cold representation data is inverted and then inputted into the error correction processing circuitry, and error correction processing is performed, thus allowing for performing error correction processing at low cost without requiring large-scale hardware, while achieving high-speed and high-performance data error correction processing.

A fifth aspect of the present invention provides the data processing device of any one of the first to third aspects of the present invention in which the first register includes a first state first split register that is a register capable of storing and retaining data, and a first state second split register that which is a register capable of storing and retaining data.

The second register includes a second state first split register that is a register capable of storing and retaining data, and a second state second split register that is a register capable of storing and retaining data.

The state obtaining processing circuitry receives a state transition control signal, determines a next state to be transitioned to based on a current state and the state transition control signal, identifies the determined state with upper and lower one-hot representation data, which are two pieces of one-hot representation data, (1) transmits the upper one-hot representation data to the first state first split register and the second state first split register, and (2) transmits the lower one-hot representation data to the first state second split register and the second state second split register.

The error correction processing circuitry (1) performs error correction processing on the data stored in the first state first split register and the data stored in the second state first split register to obtain upper one-hot representation data after error correction processing, and (2) performs error correction processing on the data stored in the first state second split register and the data stored in the second state second split register to obtain lower one-hot representation data after error correction processing.

This data processing device, in which each of the duplicated state registers is provided by a split register and one-hot representation data is adopted, allows for performing high-speed, high-performance data error correction processing while appropriately preventing an increase in the circuit scale of the required registers, even when the number of states handled by the data processing device is large.

A sixth aspect of the present invention provides the data processing device of any one of the first to third aspects of the present invention in which the state obtaining circuitry further includes an encoding circuitry, and the error processing circuitry further includes a decoding circuitry.

The state obtaining processing circuitry receives a state transition control signal, determines a next state to be transitioned to based on a current state and the state transition control signal, obtains first state data that is one-hot representation data or one-cold representation data representing the determined state, and transmits the obtained first state data to the first register.

The encoding circuitry performs bit operation processing and bit reduction processing on the first state data to obtain second state data that is bit-reduced one-hot representation data or bit-reduced one-cold representation data, and transmits the obtained second state data to the second register.

The decoding circuitry receives data stored in the second register, performs bitwise operation and bit expansion processing on the received data to obtain third state data.

The error correction processing circuitry performs error correction processing on the data stored in the first register and the third state data to obtain data after error correction processing.

In this data processing device, a state register for storing one-hot representation data and a state register for storing one-cold representation data are used to duplicate the state registers; furthermore, encoding processing (bit reduction processing) is performed by the encoding circuitry, and the one-cold representation data is stored in the state register (e.g., second register), thereby reducing the circuit scale of the state registers.

A seventh aspect of the present invention provides the data processing device of the sixth aspect of the present invention in which the encoding circuitry outputs bit position data indicating one or more bit positions where one or more bits of the one-hot representation data are “1” or one or more bits of the one-cold representation data are “0”.

The decoding circuitry performs bit expansion processing based on the bit position data.

This allows this data processing device to perform bit extension processing while taking into account bit position data.

An eighth aspect of the present invention provides a data processing method performed using a data processing device for controlling data processing by transitioning between a finite number of defined states; the data processing device comprises a first register capable of storing and retaining data and a second register capable of storing and retaining data. The data processing method includes a step (a) and a step (b).

The step (a) includes receiving a state transition control signal, determining a next state to be transitioned to based on a current state and the state transition control signal, obtaining one-hot representation data or one-cold representation data representing the determined state, and transmitting the one-hot representation data or the one-cold representation data to the first register and the second register.

The step (b) includes receiving data stored in the first register as first data, receiving data stored in the second register as second data, and performing error correction processing based on the first data and the second data to obtain data after error correction processing.

This achieves a data processing method having the same advantageous effects as the data processing device of the first aspect of the present invention.

A ninth aspect of the present invention provides a non-transitory computer readable storage medium storing a program for causing a computer to execute the data processing method according to the eighth aspects of the present invention.

This achieves a non-transitory computer readable storage medium storing a program for causing a computer to execute the data processing method having the same advantageous effects as the data processing method of the eighth aspect of the present invention.

What is claimed is:

1. A data processing device for controlling data processing by transitioning between a finite number of defined states, comprising:
a first register capable of storing and retaining data;
a second register capable of storing and retaining data;
state obtaining circuitry including state obtaining processing circuitry that receives a state transition control signal, determines a next state to be transitioned to based on a current state and the state transition control signal, obtains one-hot representation data or one-cold representation data representing the determined state, the state obtaining circuitry transmitting the one-hot representation data or the one-cold representation data to the first register and the second register;
error processing circuitry that receives data stored in the first register as first data, and receives data stored in the second register as second data, the error processing circuitry including error correction processing circuitry that performs error correction processing based on the first data and the second data to obtain data after error correction processing.

2. The data processing device according to claim 1, wherein
the error correction processing circuitry performs the error correction processing by performing an AND operation on the bits at the same bit positions of the first data and the second data.

3. The data processing device according to claim 1, wherein
the error processing circuitry further comprises error detection processing circuitry that performs error detection processing on data stored in the first register and data stored in the second register, and obtains result data of the error detection processing as error detection data.

4. The data processing device according to claim 1, wherein:
the state obtaining circuitry further includes a first inversion processing circuitry;
the error processing circuitry further includes a second inversion processing circuitry;
the state obtaining processing circuitry receives a state transition control signal, determines a next state to be transitioned to based on a current state and the state transition control signal, obtains first state data, which is one-hot representation data representing the determined state, and transmits the obtained first state data to the first register;
the first inversion processing circuitry performs bit inversion processing on the first state data to obtain second state data, which is one-cold representation data, and transmits the obtained second state data to the second register;
the second inversion processing circuitry receives data stored in the second register, and performs bit inversion processing on the received data to obtain third state data; and
the error correction processing circuitry performs error correction processing on data stored in the first register and the third state data to obtain data after error correction processing.

5. The data processing device according to claim 1,
wherein the first register comprises:
a first state first split register that is a register capable of storing and retaining data; and
a first state second split register that is a register capable of storing and retaining data, and
wherein the second register comprises:
a second state first split register that is a register capable of storing and retaining data; and
a second state second split register that is a register capable of storing and retaining data,
wherein the state obtaining processing circuitry receives a state transition control signal, determines a next state to be transitioned to based on a current state and the state transition control signal, identifies the determined state with upper and lower one-hot representation data, which are two pieces of one-hot representation data, (1) transmits the upper one-hot representation data to the first state first split register and the second state first split register, and (2) transmits the lower one-hot representation data to the first state second split register and the second state second split register, and
wherein the error correction processing circuitry (1) performs error correction processing on the data stored in the first state first split register and the data stored in the second state first split register to obtain upper one-hot representation data after error correction processing, and (2) performs error correction processing on the data stored in the first state second split register and the data stored in the second state second split register to obtain lower one-hot representation data after error correction processing.

6. The data processing device according to claim 1, wherein:
the state obtaining circuitry further includes encoding circuitry;
the error processing circuitry further includes decoding circuitry;
the state obtaining processing circuitry receives a state transition control signal, determines a next state to be transitioned to based on a current state and the state transition control signal, obtains first state data that is one-hot representation data or one-cold representation data representing the determined state, and transmits the obtained first state data to the first register;
the encoding circuitry performs bit operation processing and bit reduction processing on the first state data to obtain second state data that is bit-reduced one-hot representation data or bit-reduced one-cold representation data, and transmits the obtained second state data to the second register;
the decoding circuitry receives data stored in the second register, performs bit operation processing and bit expansion processing on the received data to obtain third state data; and
the error correction processing circuitry performs error correction processing on the data stored in the first register and the third state data to obtain data after error correction processing.

7. The data processing device according to claim 6, wherein
the encoding circuitry outputs bit position data indicating a bit position where a bit of the one-hot representation data is “1” or a bit of the one-cold representation data is “0”, and
the decoding circuitry performs bit expansion processing based on the bit position data.

8. A data processing method performed using a data processing device for controlling data processing by transitioning between a finite number of defined states, the data processing device comprising a first register capable of storing and retaining data and a second register capable of storing and retaining data, the data processing method comprising:
receiving a state transition control signal, determining a next state to be transitioned to based on a current state and the state transition control signal, obtaining one-hot representation data or one-cold representation data representing the determined state, and transmitting the one-hot representation data or the one-cold representation data to the first register and the second register; and
receiving data stored in the first register as first data, receiving data stored in the second register as second data, and performing error correction processing based on the first data and the second data to obtain data after error correction processing.

9. A non-transitory computer readable storage medium storing a program for causing a computer to execute the data processing method according to claim 8.
